(19) United States
(12) Patent Application Publication
(10) Pub. No.: US 2025/0246641 A1
(43) Pub. Date: Jul. 31, 2025

(54) SELENIUM-DOPED MAGNETIC COBALT-NICKEL SPINEL FERRITE ELECTROCATALYSTS FOR HYDROGEN EVOLUTION AND METHODS OF PREPARATION THEREOF

(71) Applicant: KING FAHD UNIVERSITY OF PETROLEUM AND MINERALS, Dhahran (SA)

(72) Inventors: Mohamed Jaffer Sadiq MOHAMED, Dhahran (SA); Muhammad Ashraf GONDAL, Dhahran (SA)

(73) Assignee: KING FAHD UNIVERSITY OF PETROLEUM AND MINERALS, Dhahran (SA)

(21) Appl. No.: 18/427,220

(22) Filed: Jan. 30, 2024

(51) Int. Cl. H01M 4/92; C01B 3/06; H01M 4/86; H01M 4/88; H01M 8/1011

(52) U.S. Cl. CPC H01M 4/921; C01B 3/06; H01M 4/8605; H01M 4/8652; H01M 4/886; H01M 4/8882; H01M 4/926; H01M 8/1011

(57) ABSTRACT

An electrocatalyst including a substrate and CoₓNi_{y}Fe₂O₄ nanoparticles, where x+y=1. The CoₓNi_{y}Fe₂O₄ nanoparticles are doped with 0.01 weight percentage (wt. %) to 1.0 wt. % selenium (Se), based on the total weight of the CoₓNi_{y}Fe₂O₄ nanoparticles. Further, the CoₓNi_{y}Fe₂O₄ nanoparticles have a polygonal shape, and the CoₓNi_{y}Fe₂O₄ nanoparticles are dispersed on the substrate to form the electrocatalyst.

### STATEMENT OF PRIOR DISCLOSURE BY INVENTOR

Aspects of the present disclosure are described in M. J. S. Mohamed, S. Caliskan, M. A. Gondal, M. A. Almessiere, A. Baykal, Y. Slimani, K. A. Elsayed, M. Hassan, I. A. Auwal, A. Z. Khan, A. A. Tahir, and A. Roy “Se-Doped Magnetic Co—Ni Spinel Ferrite Nanoparticles as Electrochemical Catalysts for Hydrogen Evolution”, ACS Applied Nano Materials; 2023; 6; 7330, incorporated herein by reference in its entirety.

Aspects of the present disclosure are described in S. Caliskan, M. A. Almessiere, A. Baykal, and Y. Slimani “A first principles study on electronic structure, magnetic and optical characteristics of Se doped CoNiFe2O4 spinel ferrites”, Computational Materials Science; 2023; 226; 112243, incorporated herein by reference in its entirety.

### STATEMENT OF ACKNOWLEDGEMENT

Support provided by the King Fahd University of Petroleum and Minerals (KFUPM) is gratefully acknowledged.

### BACKGROUND

### Technical Field

The present disclosure is directed to an electrocatalyst, and more particularly, selenium-doped magnetic cobalt-nickel spinel ferrite nanoparticles as electrocatalysts for hydrogen evolution.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Increasing fossil fuel consumption has threatened the environment and caused rapid depletion of non-renewable energy resources. Therefore, sustainable energy and storage technologies are needed that are cheap, renewable, and eco-friendly. Hydrogen fuel is considered a promising clean energy resource to compensate for the growing energy demand and to mitigate the effects of climate change. Electrocatalytic water splitting is a viable green energy technology for large-scale hydrogen production and requires an effective and long-lasting catalytic material to boost the hydrogen evolution reaction (HER).

Spinel ferrite magnetic nanoparticles are used in many applications because of their tunable optical, magnetic, and electrochemical properties. Cobalt ferrite (CoFe₂O₄) is a spinel ferrite with high mechanical hardness, reasonable magnetic anisotropy, and good chemical stability. On the other hand, nickel ferrite (NiFe₂O₄) exhibits an inverse spinal structure and has been used in many applications, including transformer cores, microwave devices, media recording, energy storage, and HER. The smaller size of a nickel (II) ion, compared with cobalt (II), also causes NiFe₂O₄ to have a smaller coercivity as well as lower magneto-crystalline anisotropy than that of cobalt (II). In addition, further alterations in the spinal ferrite structure can be achieved by doping with external impurity elements to influence the magnetic and electrochemical properties.

Although, electrocatalysts for HER have been developed in the past, there still exists a need for a transition-metal-oxide-based efficient electrocatalyst for hydrogen fuel cell applications with improved performance. It is one object of the present disclosure to provide an electrocatalyst for HER including selenium-doped magnetic cobalt-nickel spinel ferrite nanoparticles.

### SUMMARY

In an exemplary embodiment, an electrocatalyst is described. The electrocatalyst includes a substrate and CoₓNi_{y}Fe₂O₄ nanoparticles, where x+y=1. The CoₓNi_{y}Fe₂O₄ nanoparticles are doped with 0.01 weight percentage (wt. %) to 1.0 wt. % selenium (Se), based on a total weight of the CoₓNi_{y}Fe₂O₄ nanoparticles. Further, the CoₓNi_{y}Fe₂O₄ nanoparticles have a polygonal shape, and the CoₓNi_{y}Fe₂O₄ nanoparticles are dispersed on the substrate to form the electrocatalyst.

In some embodiments, the CoₓNi_{y}Fe₂O₄ nanoparticles have an average size of 5 nanometers (nm) to 20 nm.

In some embodiments, the CoₓNi_{y}Fe₂O₄ nanoparticles have a polygonal shape with 4 to 6 sides.

In some embodiments, the CoₓNi_{y}Fe₂O₄ nanoparticles are aggregated forming a porous structure.

In some embodiments, the porous structure has an average pore size of 15 nm to 26 nm.

In some embodiments, the porous structure has a Brunauer-Emmett-Teller (BET) surface area of 50 m²/g to 100 m²/g.

In some embodiments, the porous structure has a pore volume of 0.3 cm³/g to 0.6 cm³/g.

In some embodiments, the CoₓNi_{y}Fe₂O₄ nanoparticles comprise 25 wt. % to 35 wt. % 0, 30 wt. % to 40 wt. % Fe, 10 wt. % to 20 wt. % Co, 10 wt. % to 20 wt. % Ni, and 0.01 wt. % to 1.0 wt. % Se, based on a total weight of the CoₓNi_{y}Fe₂O₄ nanoparticles.

In some embodiments, the CoₓNi_{y}Fe₂O₄ nanoparticles have an average crystal size of 14 nm to 25 nm.

In some embodiments, the CoₓNi_{y}Fe₂O₄ nanoparticles have a maximum magnetization of 44 electromagnetic unit per gram (emu/g) to 48 emu/g at 10 kelvin (K).

In some embodiments, the CoₓNi_{y}Fe₂O₄ nanoparticles have a maximum magnetization of 35 emu/g to 45 emu/g at room temperature.

In some embodiments, the substrate is glassy carbon.

In another exemplary embodiment, the electrocatalyst is made by a method as described. The method includes mixing an iron salt, a nickel salt, and a cobalt salt in citric acid to form a mixture; and further adding a base to the mixture to adjust a pH to 6-8 and heating to a temperature of 350° C. to 450° C. to form nanoparticles. Further, the method includes mixing the nanoparticles with selenium and sonicating for at least 30 minutes to form a suspension. Furthermore, the method includes irradiating the suspension with a pulsed laser to form the CoₓNi_{y}Fe₂O₄ nanoparticles and coating the CoₓNi_{y}Fe₂O₄ nanoparticles on the substrate.

In some embodiments, the pulsed laser has a wavelength of 500 nm to 600 nm and a pulse duration of 5 nanoseconds (ns) to 15 ns.

In some embodiments, the mixture includes a molar ratio of the iron salt to nickel salt to cobalt salt of 1-10 to 1-10 to 1-10.

In yet another exemplary embodiment, a method of generating hydrogen is described. The method includes applying a potential of 0.1 to 1.0 V to an electrochemical cell. The electrochemical cell is at least partially submerged in an aqueous solution. Further, on applying the potential the aqueous solution is reduced thereby forming hydrogen. Furthermore, the electrochemical cell includes the electrocatalyst as aforementioned and a counter electrode.

In some embodiments, the aqueous solution further includes an acid.

In some embodiments, the electrocatalyst has an overpotential of 170 millivolts (mV) to 310 mV at a current density of 10 milliampere per square centimeter (mA/cm²).

In some embodiments, the electrocatalyst has a Tafel slope of 90 mV/decade to 120 mV/decade.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a method flowchart for making an electrocatalyst, according to certain embodiments.

FIG. 1B is a schematic representation depicting a process of preparing selenium-doped magnetic Co—Ni spinel ferrite nanoparticles (Se-doped Co—Ni NSFs) via laser ablation with improved electrochemical active surface area (ECSA), according to certain embodiments.

FIG. 2A shows X-ray diffraction (XRD) powder patterns of cobalt-nickel spinel ferrite nanoparticles (CoNi NSFs)+x % selenium (Se) where (x=0.00, 0.05, 0.10, 0.15, 0.20), according to certain embodiments.

FIG. 2B shows a Williamson-Hall (W-H) plot of CoNi NSFs at x=0.00, according to certain embodiments.

FIG. 2C shows W-H plot of CoNi NSFs at x=0.05, according to certain embodiments.

FIG. 2D shows W-H plot of CoNi NSFs at x=0.10, according to certain embodiments.

FIG. 2E shows W-H plot of CoNi NSFs at x=0.15, according to certain embodiments.

FIG. 2F shows W-H plot of CoNi NSFs at x=0.20, according to certain embodiments.

FIG. 3A is a scanning electron microscopic (SEM) micrograph of CoNi NSFs at x=0.00, according to certain embodiments.

FIG. 3B is a SEM micrograph of CoNi NSFs at x=0.05, according to certain embodiments.

FIG. 3C is a SEM micrograph of CoNi NSFs at x=0.10, according to certain embodiments.

FIG. 3D is a SEM micrograph of CoNi NSFs at x=0.15, according to certain embodiments.

FIG. 3E is a SEM micrograph of CoNi NSFs at x=0.20, according to certain embodiments.

FIG. 4A shows energy dispersive X-ray (EDX) spectrum of CoNi NSFs+x wt % Se (x=0.20), according to certain embodiments.

FIG. 4B is a transmission electron microscopic (TEM) image of CoNi NSFs+x wt % Se (x=0.20) at 100 nanometers (nm) magnification, according to certain embodiments.

FIG. 4C is a TEM image of CoNi NSFs+x wt % Se (x=0.20) at 20 nm magnification, according to certain embodiments.

FIG. 4D shows a histogram of the particle size distribution for CoNi NSFs+x wt % Se (x=0.20), according to certain embodiments.

FIG. 4E is a high-resolution transmission electron microscopy (HR-TEM) image of CoNi NSFs+wtx % Se (x=0.20), according to certain embodiments.

FIG. 5A shows nitrogen gas (N₂) adsorption-desorption isotherm of CoNiFe₂O₄+Seₓ (x=0.00-0.20 wt %), according to certain embodiments.

FIG. 5B shows pore size distributions of CoNiFe₂O₄+Seₓ (x=0.00−0.20 wt %), according to certain embodiments.

FIG. 6 shows Fourier transform infrared spectroscopy (FTIR) spectra of CoNiFe₂O₄+Seₓ at (x=0.00−0.20 wt %), according to certain embodiments.

FIG. 7A is an X-ray photoelectron spectroscopy (XPS) survey spectrum for CoNi NSFs+x wt % Se, according to certain embodiments.

FIG. 7B shows a high-resolution XPS spectrum for Ni 2p, according to certain embodiments.

FIG. 7C shows a high-resolution XPS spectrum for Fe 2p, according to certain embodiments.

FIG. 7D shows a high-resolution XPS spectrum for Co 2p, according to certain embodiments.

FIG. 7E shows a high-resolution XPS spectrum for O 1s, according to certain embodiments.

FIG. 7F shows a high-resolution XPS spectrum for Se 3d, according to certain embodiments.

FIG. 8A shows room temperature (RT) magnetic hysteresis M(H) loops in an applied field in the range of ±70 kilo oersted (kOe) of CoNi NSFs+x wt % Se (x=0.00-0.20), according to certain embodiments.

FIG. 8B shows an enlarged view of M(H) curves at room temperature (RT) in the range of −6 kOe≤H≤+6 kOe of CoNi NSFs+x % Se (x=0.00−0.20 wt %), according to certain embodiments.

FIG. 9A shows M(H) loops measured at 10 kelvin (K) and in an applied field of the range of ±70 kOe of CoNi NSFs+x % Se (x=0.00−0.20 wt %), according to certain embodiments.

FIG. 9B shows an enlarged view of M(H) curves in the range of −25 kOe≤H≤+25 kOe of CoNi NSFs+x % Se (x=0.00-0.20), according to certain embodiments.

FIG. 10A shows M(H) vs 1/H² at RT for CoNi NSFs+x % Se (x=0.00−0.20 wt %), according to certain embodiments.

FIG. 10B shows M(H) vs 1/H² at 10 K for CoNi NSFs+x % Se (x=0.00−0.20 wt %), according to certain embodiments.

FIG. 11A shows linear sweep voltammetry (LSV) polarization curves of CoNi NSFs+x % Se (x=0.00−0.20 wt %), according to certain embodiments.

FIG. 11B shows normalized overpotential histograms of CoNi NSFs+x % Se (x=0.00-0.20 wt %), according to certain embodiments.

FIG. 11C shows a comparison of hydrogen evolution reaction (HER) with various catalysts in the literature to the CoNi NSFs+x % Se (x=0.00-0.20) wt %, according to certain embodiments.

FIG. 11D shows cyclic voltammetry (CV) curve of CoNi NSFs+x % Se (x=0.00−0.20 wt %), according to certain embodiments.

FIG. 11E shows double layer capacitance (C_{dl}) plots of CoNi NSFs+x % Se (x=0.00-0.20 wt %), according to certain embodiments.

FIG. 11F shows electrochemical surface area (ECSA) histograms of CoNi NSFs+x % Se (x=0.00−0.20 wt %), according to certain embodiments.

FIG. 12A shows CV polarization curves of the CoNi NSFs without selenium, according to certain embodiments.

FIG. 12B shows CV polarization curves of the CoNi NSFs+x % Se (x=0.05 wt %), according to certain embodiments.

FIG. 12C shows CV polarization curves of the CoNi NSFs+x % Se (x=0.10 wt %), according to certain embodiments.

FIG. 12D shows CV polarization curves of the CoNi NSFs+x % Se (x=0.20 wt %), according to certain embodiments.

FIG. 13A shows electrochemical impedance spectroscopy (EIS) plots of CoNi NSFs+x % Se (x=0.00-0.20), according to certain embodiments.

FIG. 13B shows Tafel plots of CoNi NSFs+x % Se (x=0.00−0.20 wt %), according to certain embodiments.

FIG. 13C shows stability test curves of CoNi NSFs+x % Se (x=0.15 wt %), according to certain embodiments.

FIG. 13D shows chronopotentiometry curves of CoNi NSFs+x % Se (x=0.15 wt %), according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

Where a numerical limit or range is stated herein, the endpoints are included. Also, all values and subranges within a numerical limit or range are specifically included as if explicitly written out.

Furthermore, the terms “approximately”, “approximate”, “about,” and similar terms generally refer to ranges that include the identified value within a margin of 20%, 10%, or preferably 5%, and any values therebetween.

The use of the terms “include,” “includes”, “including,” “have,” “has,” or “having” should be generally understood as open-ended and non-limiting unless specifically stated otherwise.

As used herein, “nanoparticles” are particles having a particle size of 1 nm to 500 nm within the scope of the present invention.

As used herein, “magnetic materials” refers to materials that get impacted by external electromagnetic fields in their surroundings.

As used herein, “magnetic nanoparticles” refers to a class of nanoparticles that can be manipulated using magnetic fields. They include a magnetic material, such as iron, nickel, and cobalt, and a chemical component with functional groups.

As used herein, “particle size” and “pore size” may be thought of as the lengths or longest dimensions of a particle and of a pore opening, respectively.

As used herein, the term “room temperature” refers to a temperature in a range of “25° C.±3° C. in the present disclosure.

As used herein, the term ‘sonication’ refers to the process in which sound waves are used to agitate particles in a solution.

As used herein, the term “electrode” refers to an electrical conductor used to contact a non-metallic part of a circuit e.g., a semiconductor, an electrolyte, a vacuum, or air.

As used herein, the term “current density” refers to the amount of electric current traveling per unit cross-section area.

As used herein, the term “Tafel slope” refers to the relationship between the overpotential and the logarithmic current density.

As used herein, the term “electrochemical cell” refers to a device capable of either generating electrical energy from chemical reactions or using electrical energy to cause chemical reactions.

As used herein, the term “water splitting” refers to the chemical reaction in which water is broken down into oxygen and hydrogen.

2H₂O→2H₂+O₂

As used herein, the term “overpotential” “refers to the difference in potential that exists between a thermodynamically determined reduction potential of a half-reaction and the potential at which the redox event is experimentally observed. The term is directly associated with a cell's voltage efficacy. In an electrolytic cell, the occurrence of overpotential implies that the cell needs more energy as compared to that thermodynamically expected to drive a reaction. The quantity of overpotential is specific to each cell design and varies across cells and operational conditions, even for the same reaction. Overpotential is experimentally measured by determining the potential at which a given current density is reached.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopes of naturally occurring nickel ²⁸Ni include ⁵⁸Ni, ⁶⁰Ni, ⁶¹Ni, ⁶²Ni, and ⁶⁴Ni. Isotopes of iron include ⁵⁴Fe, ⁵⁶Fe, ⁵⁷Fe, and ⁵⁸Fe. Isotopes of oxygen include ¹⁶O, ¹⁷O, and ¹⁸O. Isotopes of selenium include ⁷⁴Se, ⁷⁶Se, ⁷⁷Se, ⁷⁸Se, and ⁸⁰Se and isotopes of cobalt are ⁵⁶Co, ⁵⁷Co, ⁵⁸Co and ⁶⁰Co. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed to an electrocatalyst based on magnetic CoₓNi_{y}Fe₂O₄ spinel ferrites (NSFs) with varying weight percentages of selenium. Selenium is used as a dopant to tune the magnetic and electrochemical properties of CoₓNi_{y}Fe₂O₄ structures. The results indicate that the electrocatalyst of the present disclosure demonstrated improved HER performance and outstanding electrocatalytic stability.

An electrocatalyst is described. The electrocatalyst includes a substrate and CoₓNi_{y}Fe₂O₄ nanoparticles. In some embodiments, the substrate may be made from at least one material selected from the group consisting of glassy carbon, stainless steel, aluminum, nickel, copper, platinum, zinc, tungsten, and titanium. In a specific embodiment, the substrate is glassy carbon. The substrate may have a thickness in a range of about 10 micrometers (μm) to 140 μm, for example, ranging from about 20 μm to about 120 μm, from about 50 μm to about 100 μm, from about 70 μm to about 95 μm, or from about 85 μm to about 90 μm, including all ranges and sub-ranges therebetween.

The substrate includes spinel particles dispersed on its surface to form the electrocatalyst. Spinels are any of a class of minerals of general formulation AB₂X₄ which crystallize in the cubic crystal system, with the X anions arranged in a cubic close-packed lattice and the A cations occupy tetrahedral holes, and the B cations occupy octahedral holes. In an embodiment, A is one or more selected from the group consisting of Mg, Zn, Fe, Mn, Co, Cu, Ni, Ti, or Be. In an embodiment, B is one or more selected from the group consisting of Al, Fe, Mn, Cr, and Co. In an embodiment, X is O, S or Se. In a preferred embodiment, the electrocatalyst includes a spinel ferrite AFe₂O₄. In a preferred embodiment, A is Co and Ni, thereby producing CoₓNi_{y}Fe₂O₄ nanoparticles. In some embodiments, in CoₓNi_{y}Fe₂O₄ nanoparticles, x+y=1; x is preferably 0.1, preferably 0.2, preferably 0.3, preferably 0.4, preferably 0.5, preferably 0.6, preferably 0.7, preferably 0.8, and preferably 0.9 and y is preferably 0.1, preferably 0.2, preferably 0.3, preferably 0.4, preferably 0.5, preferably 0.6, preferably 0.7, preferably 0.8, and preferably 0.9. In a preferred embodiment, x is 0.5 and y is 0.5, in other words there is an equal molar amount of Co and Ni in the nanoparticles.

In some embodiments, the CoₓNi_{y}Fe₂O₄ nanoparticles are doped with an element selected from the group consisting of S, Ge, As, Se, Sn, Sb, and Te. In preferred embodiments, the CoₓNi_{y}Fe₂O₄ nanoparticles are doped with 0.01-1.0 wt. % Se, preferably 0.02-0.9 wt. %, preferably 0.03-0.8 wt. %, preferably 0.04-0.7 wt. %, preferably 0.05-0.6 wt. %, preferably 0.06-0.5 wt. %, preferably 0.07-0.4 wt. %, preferably 0.08-0.3 wt. %, preferably 0.09-0.2 wt. %, and preferably 0.1-0.15 wt. % Se based on the total weight of the CoₓNi_{y}Fe₂O₄ nanoparticles. In an embodiment, the doped CoₓNi_{y}Fe₂O₄ nanoparticles (referred to hereafter as the nanoparticles or CoₓNi_{y}Fe₂O₄ nanoparticles) include at least one of Ni(II) and Ni(III), at least one of Co(II) and Co(III), at least one of Fe(II) and Fe(III) preferably only Fe(III), and the Se is in a −2 oxidation state.

In some embodiments, the CoₓNi_{y}Fe₂O₄ nanoparticles include 25-35 wt. %, preferably 26-34 wt. %, preferably 27-33 wt. %, preferably 28-32 wt. %, and preferably 29-31 wt. % of O; 30-40 wt. %, preferably 31-39 wt. %, preferably 32-38 wt. %, preferably 33-37 wt. %, and preferably 34-36 wt. % of Fe; 10-20 wt. %, preferably 11-19 wt. %, preferably 12-18, wt. %, preferably 13-17 wt. %, 14-16 wt. % of Co; 10-20 wt. %, preferably 11-19 wt. %, preferably 12-18 wt. %, preferably 13-17 wt. %, preferably 14-16 wt. % of Ni; and 0.01-1.0 wt. %, preferably 0.02-0.9 wt. %, preferably 0.03-0.8 wt. %, preferably 0.04-0.7 wt. %, preferably 0.05-0.6 wt. %, preferably 0.06-0.5 wt. %, preferably 0.07-0.4 wt. %, preferably 0.08-0.3 wt. %, preferably 0.09-0.2 wt. %, and preferably 0.1-0.15 wt. % of Se based on the total weight of the CoₓNi_{y}Fe₂O₄ nanoparticles.

In some embodiments, the nanoparticles may have many shapes, such as cones, cuboidal, pyramidical, cylindrical, wires, crystals, rectangles, triangles, prisms, disks, cubes, ribbons, blocks, beads, discs, barrels, granules, whiskers, flakes, foils, powders, boxes, stars, flowers, polygonal like trigonal, pentagonal, hexagonal, etc., and mixtures thereof. In a specific embodiment, the CoₓNi_{y}Fe₂O₄ nanoparticles have a polygonal shape. In some embodiments, the CoₓNi_{y}Fe₂O₄ nanoparticles have a polygonal shape with 4-6 sides, preferably 4 sides, preferably 5 sides, and preferably 6 sides.

In some embodiments, the CoₓNi_{y}Fe₂O₄ nanoparticles have an average size of 5-20 nanometers (nm), preferably 6-19 nm, preferably 7-18 nm, preferably 8-17 nm, preferably 9-16 nm, preferably 10-15 nm, preferably 11-14 nm, and preferably 12-13 nm. In some embodiments, the CoₓNi_{y}Fe₂O₄ nanoparticles have an average crystal size of 14-25 nm, preferably 15-24 nm, preferably 16-23 nm, preferably 17-22 nm, preferably 18-21 nm, and preferably 19-20 nm. The cell constants increased by increasing the amount of Se due to the expansion in the crystal. In some embodiments, the Se replaces O atoms in the crystal structure thereby causing crystal defects and tensile strain because Se is larger than O. In some embodiments, the Se affects the distance, preferably decreases a distance, between the Co, Ni and Fe atoms in the crystal structure, thereby creating a nonuniform particle distribution.

In some embodiments, the CoₓNi_{y}Fe₂O₄ nanoparticles are aggregated forming a porous structure. Pores may be micropores, mesopores, macropores, and/or a combination thereof. In some embodiments, the porous structure has an average pore size of 15-26 nm, 16-25 nm, preferably 17-24 nm, preferably 18-23 nm, preferably 19-22 nm, and preferably 20-21 nm. In a preferred embodiment, the porous structure has an average pore size of 25 nm. In some embodiments, the porous structure has a Brunauer-Emmett-Teller (BET) surface area of 50-100 meter square per gram (m²/g), preferably 55-95 m²/g, preferably 60-90 m²/g, preferably 65-85 m²/g, and preferably 70-80 m²/g. In a preferred embodiment, the porous structure has a BET surface area of 57 m²/g. In some embodiments, the porous structure has a pore volume of 0.3-0.6 cubic centimeters per gram (cm³/g), preferably 0.35-0.55 cm³/g, and preferably 0.4-0.5 cm³/g. In a preferred embodiment, the porous structure has a pore volume of 0.35 cm³/g.

In some embodiments, the CoₓNi_{y}Fe₂O₄ nanoparticles have a maximum magnetization of 35-45 electromagnetic unit per gram (emu/g), preferably 36-44 emu/g, preferably 37-43 emu/g, preferably 38-42 emu/g, and preferably 39-41 emu/g at room temperature. In some embodiments, the CoₓNi_{y}Fe₂O₄ nanoparticles have a maximum magnetization of 44-48 emu/g, and preferably 45-46 emu/g at 10 kelvin (K).

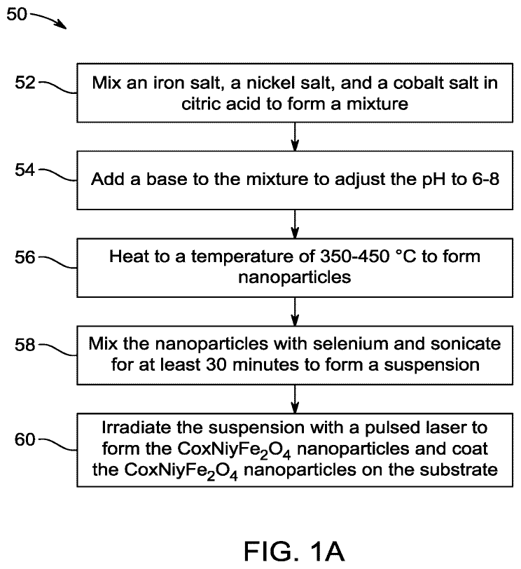

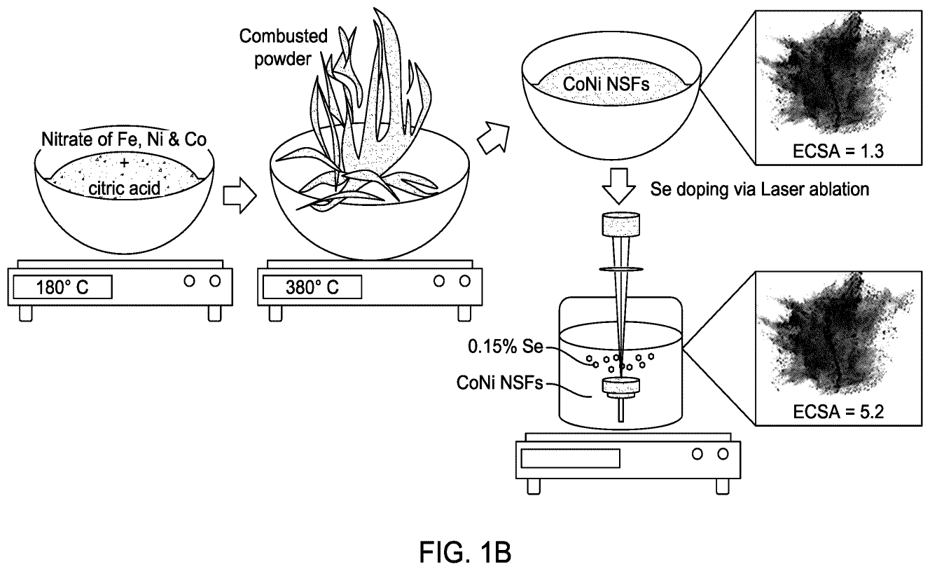

FIG. 1A illustrates a flow chart of a method 50 of a method of making an electrocatalyst. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing an iron salt, a nickel salt, and a cobalt salt in citric acid to form a mixture. The mixing may be carried out manually or with the help of a stirrer. Suitable examples of iron salts include iron bromide, iron chloride, iron phosphate hydrate, iron phosphate tetrahydrate, iron chloride hydrate, iron chloride tetrahydrate, iron fluoride, ammonium iron sulfate hexahydrate, iron citrate tribasic monohydrate, iron gluconate dehydrate, iron pyrophosphate, iron phthalocyanine, iron phthalocyanine chloride, ammonium iron citrate, ammonium iron sulfate, ammonium iron sulfate, ammonium iron sulfate dodecahydrate, iron chloride, iron bromide, iron chloride hexahydrate, ferric citrate, iron fluoride, iron nitrate nonahydrate, iron oxide, iron phosphate, iron sulfate hydrate, iron gluconate hydrate, iron iodide, iron lactate hydrate, iron oxalate dehydrate, ferrous sulfate heptahydrate, iron sulfide, iron acetate, iron fluoride tetrahydrate, iron iodide tetrahydrate, iron perchlorate hydrate, iron acetylacetonate, iron acetylacetonate, and iron ascorbate and/or its hydrate. In a specific embodiment, the iron salt is iron nitrate nonahydrate Fe(NO₃)₃·9H₂O.

Suitable examples of nickel salt include nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate. In a specific embodiment, the nickel salt is nickel nitrate hexahydrate [Ni(NO₃)₂·6H₂O].

Suitable examples of cobalt salts include cobalt chloride, chloropentahammine cobalt chloride, hexaammine cobalt chloride, cobalt phosphate, cobalt phosphate, ammonium cobalt sulfate, diammonium tetra nitrate cobalt, cobalt acetate, cobalt formate, cobalt tetraoxide, cobalt bromide, cobalt oxalate, cobalt selenate, cobalt tungstate, cobalt molybdate, cobalt iodide, and cobalt phosphate or its hydrate. In a specific embodiment, the cobalt salt is cobalt nitrate hexahydrate [Co(NO₃)₂·6H₂O)]. In some embodiments, the mixture includes a molar ratio of the iron salt to nickel salt to cobalt salt of 1-10:1-10:1-10. In a preferred embodiment, the molar ratio of the iron salt to nickel salt to cobalt salt is 2:1:1.

At step 54, the method 50 includes adding a base to the mixture to adjust a pH to 6-8, preferably 6, preferably 7, and preferably 8. The base may be organic or inorganic. Suitable examples of base include alkaline earth metal hydroxides such as beryllium hydroxide (Be(OH)₂), magnesium hydroxide (Mg(OH)₂), strontium hydroxide (Sr(OH)₂), and calcium hydroxide (Ca(OH)₂); alkali metal hydroxides such as lithium hydroxide (LiOH), sodium hydroxide (NaOH), potassium hydroxide (KOH) and rubidium hydroxide (RbOH), and cesium hydroxide (CsOH); ammonia (NH₃), organic bases such as sodium acetate, potassium acetate, pyridine, and imidazole. In a preferred embodiment, the base is NH₃.

At step 56, the method 50 includes heating to a temperature of 350-450° C., preferably 360-440° C., preferably 370-430° C., preferably 380-420° C., and preferably 390-410° C., to form nanoparticles. In a preferred embodiment, the method includes heating to a temperature of 380° C. The heating can be done by using heating appliances such as hot plates, heating mantles ovens, microwaves, autoclaves, tapes, oil baths, salt baths, sand baths, air baths, hot-tube furnaces, and hot-air guns.

At step 58, the method 50 includes mixing the nanoparticles with selenium, preferably selenium metal, and sonicating for at least 30 minutes (min), preferably 35 min, preferably 40 min, preferably 45 min, preferably 50 min, preferably 55 min, preferably 60 min, and preferably 65 min to form a suspension. In some embodiments, the sonication is at a power of 60-80 W, preferably 70 W and a frequency of 10-30 kHz, preferably 20 kHz. In a preferred embodiment, the mixing of the nanoparticles was carried out by sonication of the nanoparticles with selenium for 60 min (1 h).

At step 60, the method 50 includes irradiating the suspension with a pulsed laser to form the CoₓNi_{y}Fe₂O₄ nanoparticles and coating the CoₓNi_{y}Fe₂O₄ nanoparticles on the substrate. In some embodiments, the pulsed laser has a wavelength of 500-600 nm, preferably 510-590 nm, preferably 520-580 nm, preferably 530-570 nm, and preferably 540-560 nm, and a pulse duration of 5-15 nanoseconds (ns), preferably 6-14 ns, preferably 7-13 ns, preferably 8-12 ns, and preferably 9-11 ns. In a preferred embodiment, the pulsed laser has a wavelength of 532 nm and a pulse duration of 9 ns. The resulting nanoparticles are then coated on the substrate by any method known in the art such as drop-casting or spin-coating.

A method for generating hydrogen i.e., the hydrogen evolution reaction (HER) is described. The method includes applying a potential of greater than 0.1-1.0 volts (V), preferably 0.2-0.9 V, preferably 0.3-0.8 V, preferably 0.4-0.7 V, and preferably 0.5-0.6 V to an electrochemical cell. On applying the potential, the aqueous solution is reduced thereby forming hydrogen. In some embodiments, the electrochemical cell is at least partially submerged in an aqueous solution, preferably 50%, preferably 60%, or more preferably at least 70%. In some embodiments, the aqueous solution includes an acid. The acid acts as an electrolyte solution. Suitable examples of acids include hydrochloric acid (HCl), sulfuric acid (H₂SO₄), hydrofluoric acid (HF), or a mixture thereof. In a preferred embodiment, the acid is H₂SO₄. The aqueous solution also includes water. The water may be tap water, distilled water, bidistilled water, deionized water, deionized distilled water, reverse osmosis water, and/or some other water. The acid is preferably at a concentration of 0.05-1 molar (M), preferably 0.1-0.75 M, and more preferably 0.25-0.5 M. In a preferred embodiment, the acid is preferably at a concentration of 0.5 M.

In an embodiment, the electrochemical cell includes the CoₓNi_{y}Fe₂O₄-based electrode (also referred to as a working electrode) and a counter electrode. In some embodiments, the counter electrode may contain an electrically-conductive material such as platinum, platinum-iridium alloy, iridium, titanium, titanium alloy, stainless steel, gold, cobalt alloy, and/or some other electrically-conductive material, where an “electrically-conductive material” as defined here is a substance with an electrical resistivity of at most 10-6 ohms meter (Ω·m), preferably at most 10⁻⁷ Ω·m, more preferably at most 10⁻⁸ Ω·m at a temperature of 20-25° C. The form of the counter electrode may be generally relevant only in that it needs to supply sufficient current to the electrolyte solution to support the current required for the electrochemical reaction of interest. The material of the counter electrode should thus be sufficiently inert to withstand the chemical conditions in the electrolyte solution, such as acidic or basic pH values, without substantially degrading during the electrochemical reaction. The counter electrode preferably should not leach out any chemical substance that interferes with the electrochemical reaction or lead to undesirable contamination of either electrode. In a preferred embodiment, the counter electrode is platinum. In a preferred embodiment, the counter electrode includes any material which is capable of undergoing oxygen evolution reaction (OER). The counter electrode is complementary to the electrocatalyst of the present disclosure which undergoes the hydrogen evolution reaction (HER) in water splitting.

In one embodiment, the electrochemical cell further includes a reference electrode in contact with the electrolyte solution. A reference electrode is an electrode that has a stable and well-known electrode potential. The high stability of the electrode potential is usually reached by employing a redox system with constant (buffered or saturated) concentrations of each relevant species of the redox reaction. A reference electrode may enable a potentiostat to deliver a stable voltage to the working electrode or the counter electrode. The reference electrode may be a standard hydrogen electrode (SHE), a normal hydrogen electrode (NHE), a reversible hydrogen electrode (RHE), a saturated calomel electrode (SCE), a copper-copper (II) sulfate electrode (CSE), a silver chloride electrode (Ag/AgCl), a pH-electrode, a palladium-hydrogen electrode, a dynamic hydrogen electrode (DHE), a mercury-mercurous sulfate electrode, or some other type of electrode. In a preferred embodiment, a reference electrode is present and is Ag/AgCl electrode. However, in some embodiments, the electrochemical cell does not include a third electrode.

Preferably, to maintain uniform concentrations and/or temperatures of the electrolyte solution, the electrolyte solution may be stirred or agitated during the step of the subjecting. The stirring or agitating may be done intermittently or continuously. This stirring or agitating may be done by a magnetic stir bar, a stirring rod, an impeller, a shaking platform, a pump, a sonicator, a gas bubbler, or some other device. Preferably the stirring is done by an impeller or a magnetic stir bar.

In some embodiments, the working electrode and the counter-electrode are connected to each other by way of electrical interconnects that allow for the passage of current between the electrodes, when a potential is applied between them. In a preferred embodiment, the working electrode and the counter electrode are at least partially submerged in the water and are not in physical contact with each other. In an embodiment, the working electrode and the counter-electrode can have the same or different dimensions.

In one embodiment, the potential may be applied to the electrodes by a battery, such as a battery including one or more electrochemical cells of alkaline, lithium, lithium-ion, nickel-cadmium, nickel metal hydride, zinc-air, silver oxide, and/or carbon-zinc. In another embodiment, the potential may be applied through a potentiostat or some other source of direct current, such as a photovoltaic cell. In one embodiment, a potentiostat may be powered by an AC adaptor, which is plugged into a standard building or home electric utility line. In one embodiment, the potentiostat may connect with a reference electrode in the electrolyte solution. Preferably the potentiostat is able to supply a relatively stable voltage or potential. For example, in one embodiment, the electrochemical cell is subjected to a voltage that does not vary by more than 5%, preferably by no more than 3%, preferably by no more than 1.5% of an average value throughout the subjecting. In another embodiment, the voltage may be modulated, such as being increased or decreased linearly, being applied as pulses, or being applied with an alternating current.

In one embodiment, the method further comprises the step of separately collecting H₂-enriched gas and O₂-enriched gas. In one embodiment, the space above each electrode may be confined to a vessel in order to receive or store the evolved gases from one or both electrodes. The collected gas may be further processed, filtered, or compressed. Preferably the H₂-enriched gas is collected above the cathode, and the O₂-enriched gas is collected above the anode. The electrolytic cell, or an attachment, may be shaped so that the headspace above the working electrode is kept separate from the headspace above the counter electrode. In one embodiment, the H₂-enriched gas and the O₂-enriched gas are not 100 vol % H₂ and 100 vol % O₂, respectively. For example, the enriched gases may also comprise N₂ from the air, water vapor, and other dissolved gases from the electrolyte solution. The H₂-enriched gas may also comprise O₂ from the air. The H₂-enriched gas may comprise greater than 20 vol % H₂, preferably greater than 40 vol % H₂, more preferably greater than 60 vol % H₂, and even more preferably greater than 80 vol % H₂, relative to a total volume of the receptacle collecting the evolved H₂ gas. The O₂-enriched gas may include greater than 20 vol % O₂, preferably greater than 40 vol % O₂, more preferably greater than 60 vol % O₂, and even more preferably greater than 80 vol % O₂, relative to a total volume of the receptacle collecting the evolved O₂ gas. In some embodiments, the evolved gases may be bubbled into a vessel comprising water or some other liquid, and higher concentrations of O₂ or H₂ may be collected. In one embodiment, evolved O₂ and H₂, or H₂-enriched gas and O₂-enriched gas, may be collected in the same vessel.

Several parameters for the method for decomposing water may be modified to lead to different reaction rates, yields, and other outcomes. These parameters include but are not limited to, electrolyte type and concentration, pH, pressure, solution temperature, current, voltage, stirring rate, electrode surface area, size of manganese oxide particles, porosity, and exposure time. A variable DC current may be applied at a fixed voltage, or a fixed DC current may be applied at a variable voltage. In some instances, AC current or pulsed current may be used. A person having ordinary skill in the art may be able to adjust these and other parameters, to achieve different desired nanostructures. In other embodiments, the electrochemical cell may be used for other electrochemical reactions or analyses.

In some embodiments, the electrocatalyst has a Tafel slope of 90-120 millivolt/decade (mV dec⁻¹), preferably 95-115 mV dec⁻¹, and preferably 100-110 mV dec⁻¹. In a specific embodiment, the electrocatalyst has a Tafel slope of 91 mV dec⁻¹, when an amount of Se is 0.15 wt. %. In some embodiments, the electrochemical cell has an overpotential of 170-310 millivolts (mV), preferably 180-300 mV, preferably 190-290 mV, preferably 200-280 mV, preferably 210-270 mV, preferably 220-260 mV, and preferably 230-250 mV at a current density of 10 mA/cm². In a specific embodiment, the electrocatalyst has an overpotential of 173.5 mV at a current density of 10 mA/cm², when an amount of Se is 0.15 wt. %. In some embodiments, the electrocatalyst has an electrochemical active surface area (ECSA) of 3-6 cm², preferably 4-5 cm². In a specific embodiment, the electrocatalyst has an ECSA of 5.2 cm², when an amount of Se is 0.15 wt. %.

While not wishing to be bound to a single theory, it is thought that doping the CoₓNi_{y}Fe₂O₄ with selenium by the unique synthesis method, provides particles with a unique morphology and crystal structure which affects the magnetism and electrochemical performance. The Se decreases a distance, between the Co, Ni and Fe atoms in the crystal structure, thereby creating a nonuniform particle distribution, increasing the electrochemical surface area, and resulting in many defective sites, which are advantageous for the rapid transfer of charges. However, when too much Se is doped, the Se can aggregate and cover the active sites making more recombination centers.

### EXAMPLES

The following examples demonstrate the electrochemical catalysts for hydrogen evolution reaction (HER) and, subsequently, the generation of hydrogen gas. The examples are provided solely for illustration and are not to be construed as limitations of the present disclosure, as many variations thereof are possible without departing from the spirit and scope of the present disclosure.

### Example 1: Material and Methods

Cobalt-nickel (Co—Ni or CoNi) spinel ferrite nanoparticles (NSFs)+x % selenium (Se), where x=0.00, 0.05, 0.10, 0.15, 0.20, were prepared using a modified sol-gel auto-combustion process followed by a green laser ablation technique (FIG. 1B). In the Examples herein x % refers to the weight percent of selenium in the nanoparticles having a formula of, e.g., Co_{0.5}Ni_{0.5}Fe₂O₄. Chemicals including Fe(NO₃)₃·9H₂O (3.23 g), Co(NO₃)₂·6H₂O (0.64 g), C₆H₈O₇·H₂O (3.0 g) and Se (0.0, 1.0, 2.0, 3.0 and 4.0 g) metal were purchased from Merck and used without further treatment.

### Example 2: Synthesis of CoNi NSFs+x % Se (x=0.00−0.20)

CoNi NSFs+x % Se (x=0.00−0.20) were produced via a sol-gel auto-combustion followed by a green laser ablation method. CoNi NSFs were prepared by using Co(NO₃)₂·6H₂O, Ni(NO₃)₂·6H₂O and Fe(NO₃)₃·9H₂O, and high purity citric acid as primary materials mixed with 50 mL deionized water (DI H₂O) at 80° C. with continuous stirring. Later, drops of NH₃ solution were added to regulate the pH at 7 to form a brown solution. The temperature was kept at 180° C. for 35 minutes and, finally, at 380° C. until a viscous gel was obtained, which was then burned to become a black powder. To synthesize CoNi NSFs+x % Se, a specific ratio of Se was added to CoNi NSFs in 25 mL of DI water, and the mixture was exposed to ultrasonication (ultrasonic homogenizer UZ Sonopuls HD 2070; 70 W and 20 kHz) for 1 hour (h). Further, the resultant mixture containing (CoNi NSFs+x % Se) was irradiated by QSwitched Nd-YAG laser with 532 nanometers (nm) wavelength and 9 nanoseconds (ns) pulse duration. The intensity of the laser beam was further increased by using a focusing lens, and irradiation time was fixed to 40 minutes for each sample under continuous stirring. The resulting suspension containing doped magnetic nanoparticles was dried at 120° C. for 2 h. The rest of the samples (CoNi NSF+x % Se) with different weight percentages (wt. %) of Se were synthesized using the same procedure. During the PLAL procedure synthesis, the plasma plume was generated inside the (CoNi NSFs+x % Se) suspension caused by the high-energy laser pulses and the interaction amongst the particles inside the suspension. These pulses created acoustic cavitation bubbles in the liquid that became larger and collapsed to create shockwaves inside the medium. The shock wave generated from the temperature gradient inside the suspension led to forming CoNi NSFs+x % Se nanoparticles within a short period, around 450 microseconds (μs).

### Example 3: Material Characterization Techniques

The CoNi NSFs+x % Se (x=0.00-0.20) phase was investigated via a Rigaku Benchtop Miniflex X-ray diffractometer (XRD) (λ=1.54059 Å) (Rigaku, Japan). The morphology, including the shape and size of the magnetic nanoparticles, was explored by scanning electron microscope (SEM), transmission electron microscope (TEM) (Titan-FEI-Morgagni-268), and elemental analysis/mapping was performed with energy-dispersive X-ray spectroscopy (EDX) method attached with the SEM. The Fourier transform infrared (FTIR) spectra were recorded by an FT-IR spectrometer in Bruker, United States. The chemical environment and oxidation states of the elements were studied using an X-ray photoelectron spectroscopy (XPS) (Kratos DLD, United States) instrument. Magnetization results were performed using a physical property measurement system (PPMS) (Quantum Design PPMS DynaCool-9) coupled with VSM. The textural properties were determined using a Micromeritics ASAP 2020 automatic analyzer using N₂ adsorption-desorption at −195° C. Samples were heated at 160° C. for 3 hours to degas and evaporate the moisture and air gases. The surface area was obtained using the Brunauer-Emmet-Teller (BET) method within the relative pressure (p/p0) range of 0.05-0.20, and the pore size distribution was calculated by the Barret-Joyner-Halenda (BJH) method. The nitrogen adsorption volume at the relative pressure (p/p₀) of 0.99 was used to determine the pore volume.

### Example 4: Electrochemical Characterization Techniques and Electrode Preparation

A computer-controlled potentiostat (Metrohm AutoLab PGSTAT302N) was used to conduct the electrochemical HER performances of CoNi NSFs+x % Se (x=0.00−0.20) in a standard three-electrode chemical cell. The electrochemical cell contained glassy carbon as the working electrode, Ag/AgCl electrode (3.5 M KCl solution) as the reference electrode, and platinum electrode as the counter electrode submerged in 0.5 M H₂SO₄ as an electrolyte (pH=0.3). The working electrode was bare and electrocatalyst-modified glassy carbon (GC) electrodes with a 3 mm diameter. The steps mentioned hereinafter were employed to prepare the ink and electrode fabrication process. Firstly, 4 mg of catalyst was thawed in 80% water+20% ethanol (in volume) mixture containing 80 microliters (μL) of 5% Nafion solution. The ultrasonication was carried out for 30 minutes to ensure the solution was completely dispersed. The modified GC electrode was prepared by a 10 μL drop cast of the above mixture, and then the electrode was dried at 80° C. for 2 h for a catalyst loading of 0.285 mg/cm². The catalytic performance of the electrodes was evaluated by LSV (linear sweep voltammetry) with a 10 mV/s scan rate in a 0.5 M H₂SO₄ aqueous solution. The reversible hydrogen electrode potential (E_{RHE}) was applied to facilitate the comparison of prepared electrodes at all potentials and evaluated by using the Nernst relation,

$$( {E}_{RHE} = {E}_{a p p l i e d} + 0.0591 \cdot pH + {E}_{Ag / AgCl} )$$

where E_{applied} and E_{RHE} are the applied potential and reference electrode potential, respectively, and equal to 0.198 V vs RHE. Electrochemical impedance spectroscopy (EIS) measurements were performed from 10-1 to 105 Hz with a 10 mV amplitude. The ECSA (electrochemically active surface area) of the electrode may be calculated (ECSA=C_{dl}/Cₛ). The C_{dl} (double-layer capacitance) value of the representative electrodes was evaluated by measuring the cyclic voltammetry (CV) in a non-faradic region at different scan rates of 20 mV/s to 120 mV/s. The Cₛ is the specific capacitance with a value of 0.040 mF/cm².

### Example 5: XRD Analysis

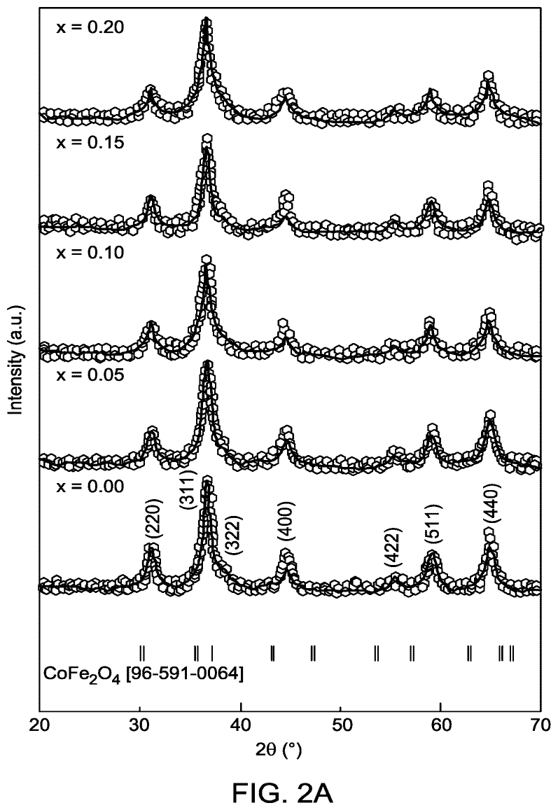

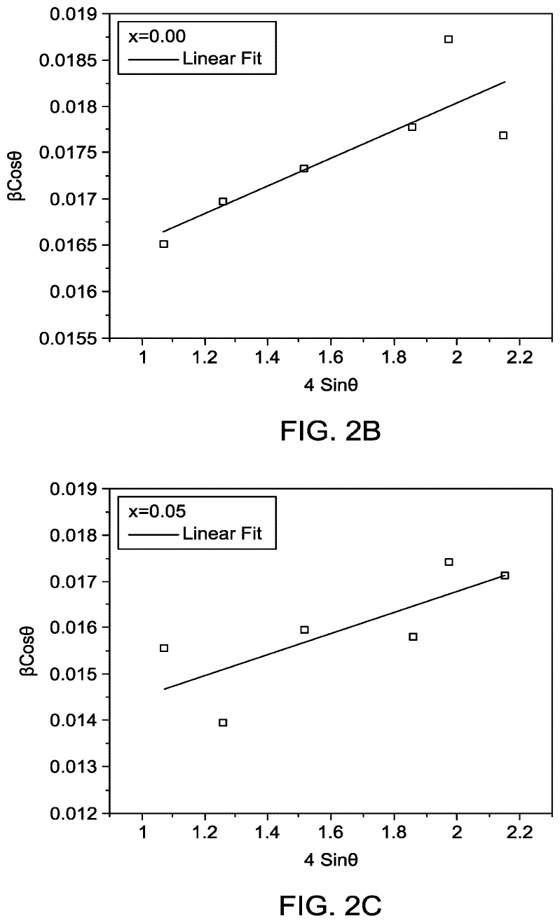

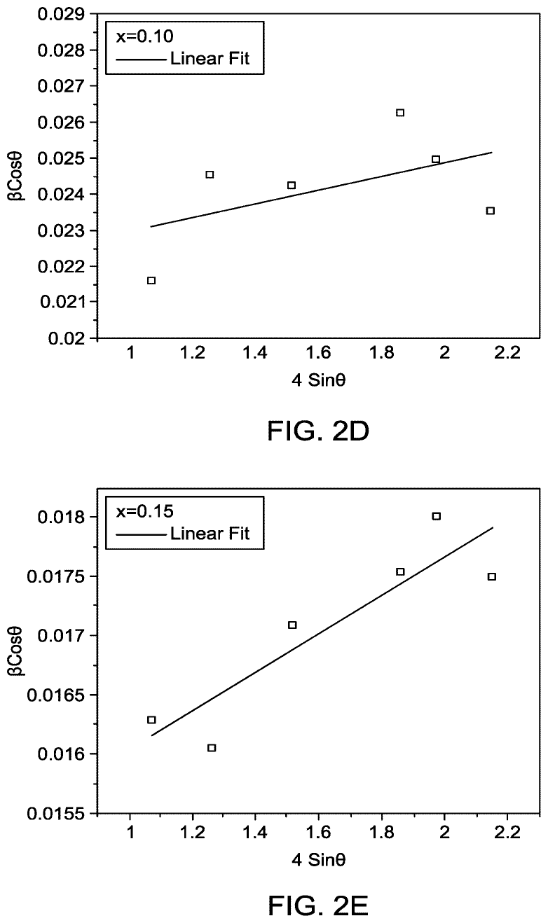

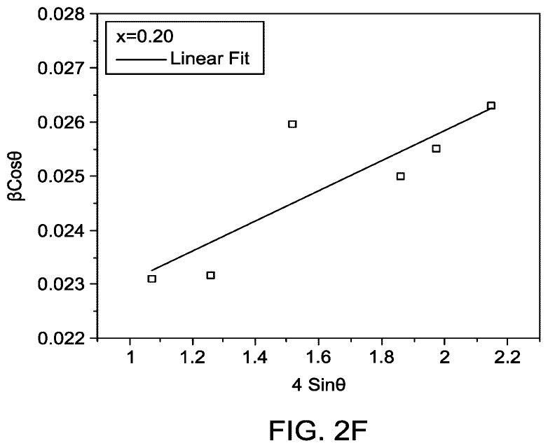

The microstructure CoNi NSFs+x % Se (x=0.00-0.20) is screened by XRD analysis as illustrated in FIG. 2A. FIG. 2A indicates the presence of a pure phase of spinel ferrite of CoFe₂O₄ (JCPDS card: 22-1086). Further, the purity of the spinel phase was confirmed via Rietveld refinement fitting that used experimental XRD data employing Match 3! Fullproof software. The crystal size, cell constant, volume, and reliability parameters are depicted in Table 1.

TABLE 1
Rietveld refined structure parameters of CoNi NSFs +
x % Se (x = 0.00-0.20).

| | | | D_{XRD} (nm) ± | Strain | | |
|---|---|---|---|---|---|---|
| x % | a(Å) | V (Å³) | 0.03 | (×10⁻⁴) | c² | R_{Bragg} |
| 0.00 | 8.3592 | 584.10 | 13.8 | 14.9 | 1.9 | 11.3 |
| 0.05 | 8.3767 | 589.78 | 18.4 | 22.7 | 1.6 | 31.6 |
| 0.10 | 8.3814 | 588.78 | 15.7 | 18.9 | 2.0 | 24.3 |
| 0.15 | 8.3902 | 590.62 | 14.4 | 16.3 | 2.0 | 29.0 |
| 0.20 | 8.3913 | 590.87 | 24.8 | 27.7 | 1.9 | 27.7 |

It was found that the cell constants are increased by increasing the amount of Se due to the expansion in the CoNi NSF crystal. The different intensities of 220 and 400 diffraction peaks are slightly changed, such as, when increased, the quantity of Se results from the stresses in the crystal in the direction of the 220 and 400 planes. The Debye-Scherrer equation based on the 311 peaks was used to calculate the average crystal sizes and found within a 13 nm to 24 nm range. The lattice strain of CoNi NSFs+x % Se (x=0.00−0.20) was estimated via the Williamson-Hall (W-H) equation by plotting the straight line of β cos θ vs 4 sin θ as shown in FIGS. 2B-2F. The slope of the W-H plots indicated the lattice strain of all samples, as given in Table 1. In all, ratios showed a positive strain due to the samples holding a tensile strain by adding Se.

### Example 6: SEM and TEM Analysis

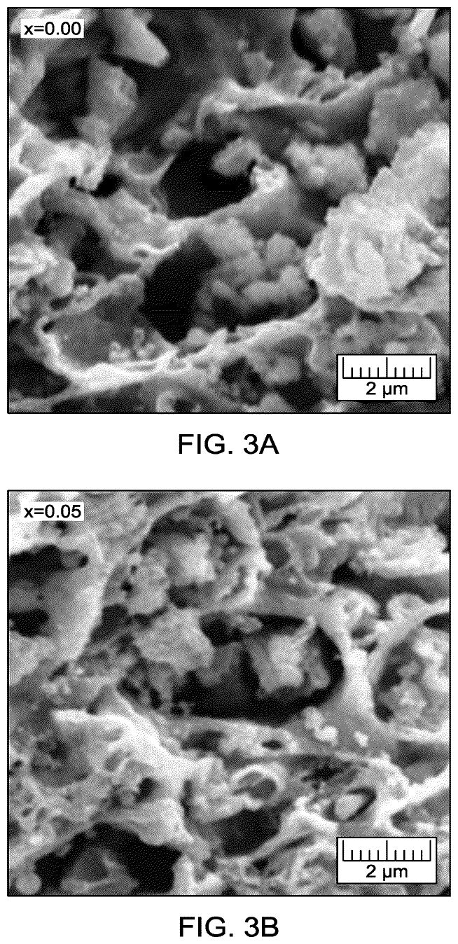

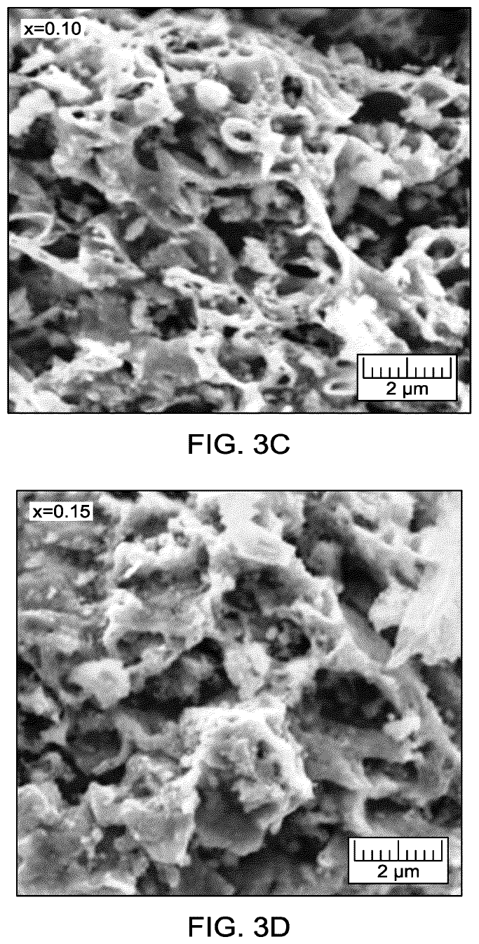

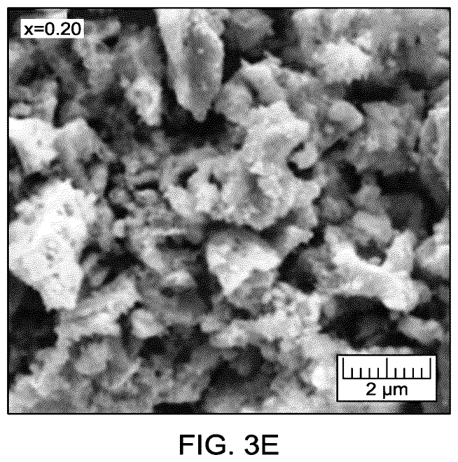

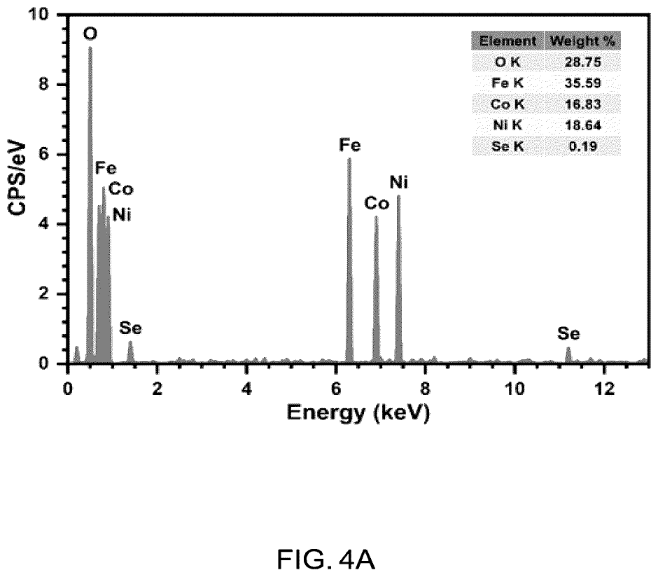

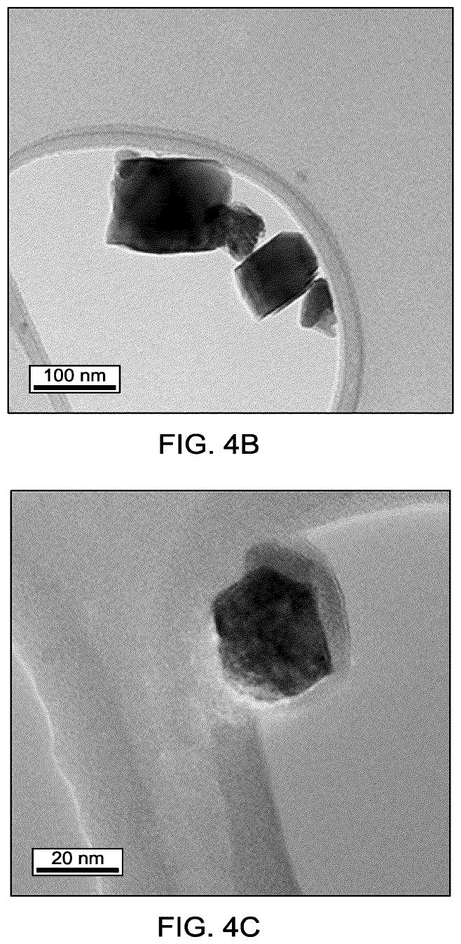

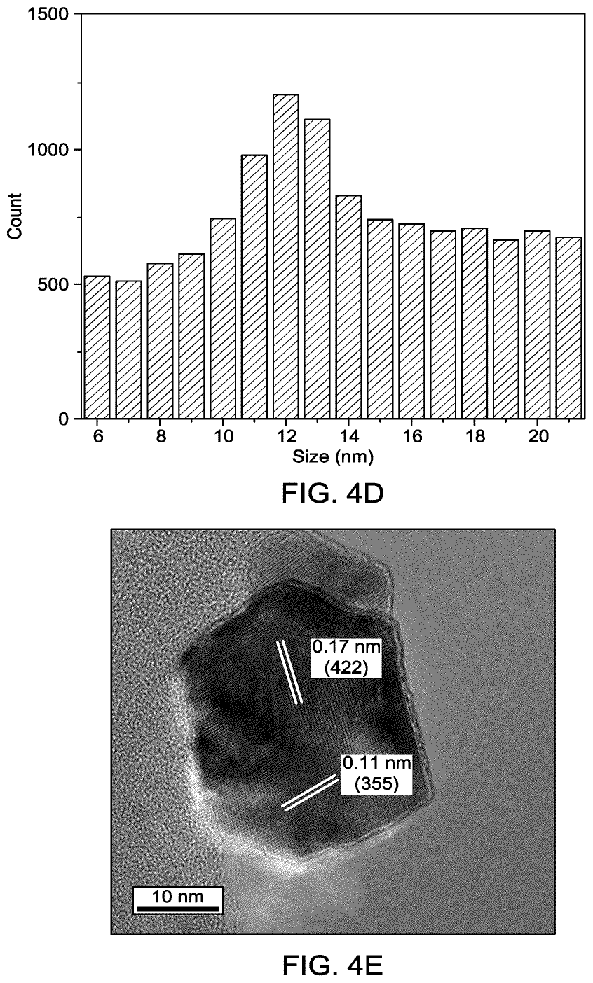

The microstructure of CoNi NSFs+x % Se (x=0.00−0.20) was analyzed through SEM, as illustrated by images depicted in FIGS. 3A-3E. The ratios show an aggregation of tiny spherical particles. The CoNi NSFs+x % Se (x=0.00−0.20) revealed a high porosity in bare CoNi NSFs (x=0.0) and decreased after increasing the Se content in the matrix. The composition of CoNi NSFs+x % Se (x=0.20) was recorded by EDX and is illustrated in FIG. 4A. The EDX spectra revealed the occurrence of the Ni, Fe, Co, O, and Se elements, which indicates the efficacy of the green laser ablation method. For further morphological analysis of CoNi NSFs+x % Se (x=0.20), TEM and high-resolution transmission electron microscopy (HR-TEM) were employed, and such images are presented in FIGS. 4B-4E. FIG. 4D shows a histogram of the particle size distribution and FIG. 4E is a high-resolution transmission electron microscopy (HR-TEM) image of CoNi NSFs+x % Se (x=0.00−0.20). The TEM image illustrated the semi-cubic particles with different sizes. The HR-TEM image confirmed the structure of pure CoNi NSF by calculating the lattice planer using GATAN software, which revealed that 0.17 nm and 0.11 nm correspond to the Miller indices 422 and 355, respectively.

### Example 7: Surface Area Analysis

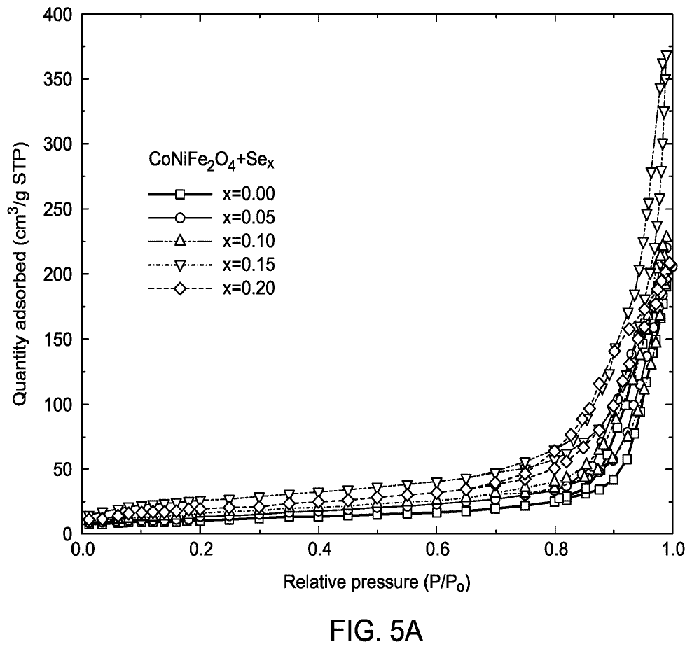

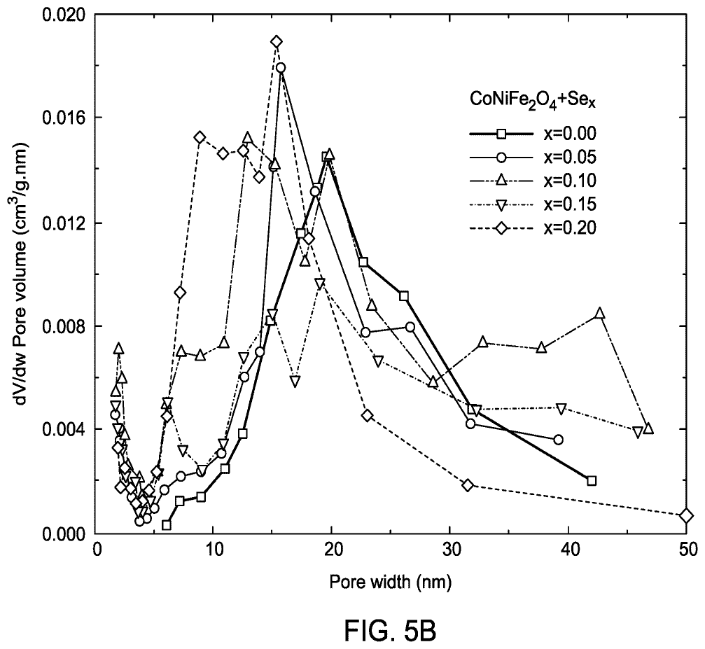

The surface area and pore size distribution of CoNi NSFs+x % Se (x=0.00-0.20) NSFs were analyzed using the nitrogen adsorption-desorption isotherm technique, as shown in FIG. 5A and Table 2. The Brunauer-Emmet-Teller (BET) isotherm of CoSeFeO₄ indicated a type III pattern (H₃ hysteresis), reflecting the presence of mesoporous characteristics with the addition of Se. CoNi NSFs+x % Se (x=0.00) showed a surface area of 40 m²/g and a pore volume of 0.29 cm³/g, which then increased to the maximum of 90 m²/g and 0.57 cm³/g with Se addition. The Barrett-Joyner-Halenda (BJH) pore size distribution (FIG. 5B) indicated a concomitant reduction in pore diameter from 18 nm to 30 nm (x=0.00−0.20). Overall, the analysis showed that the surface textural variation with Se addition enhanced the surface area and pore volume of CoNi NSFs.

TABLE 2
Surface area and pore size distribution properties
of CoNi NSFs + x % Se (x = 0.00-0.20).

| | BET surface | Pore volume | Average pore |
|---|---|---|---|
| x | area m²/g | cm³/g | size (nm) |
| 0.00 | 40 | 0.29 | 30 |
| 0.05 | 53 | 0.34 | 26 |
| 0.10 | 90 | 0.57 | 25 |
| 0.15 | 57 | 0.35 | 25 |
| 0.20 | 69 | 0.31 | 18 |

### Example 8: FTIR Analysis

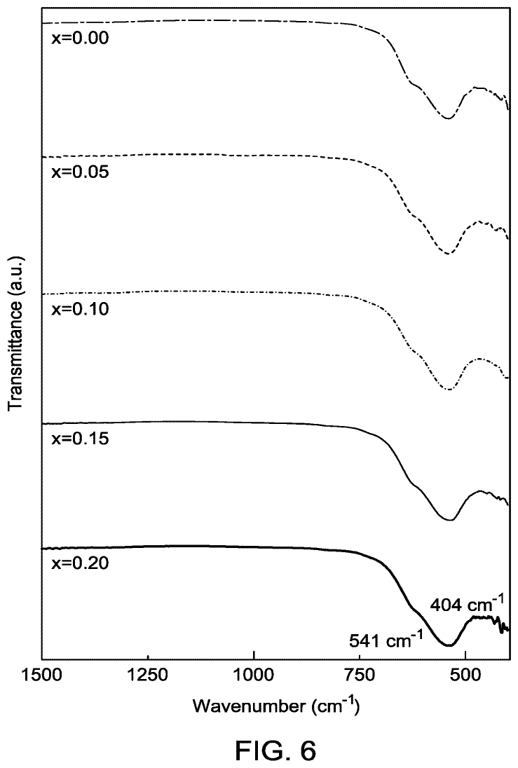

FIG. 6 illustrates the FTIR spectra of CoNi NSFs+x % Se (x=0.00−0.20) in the range of 400 cm⁻¹ to 4000 cm⁻¹. The spectra displayed two absorption bands v1 and v2 at 404 cm⁻¹ and 541 cm⁻¹, respectively, which are characteristics of spinel ferrites. The 404 cm 1 acts as the metal-oxygen vibrations in the octahedral site, whereas 541 cm⁻¹ represents vibrations of metal-oxygen in the tetrahedral site. These results indicated the formation of Co—Ni spinel ferrite.

### Example 9: XPS Analysis

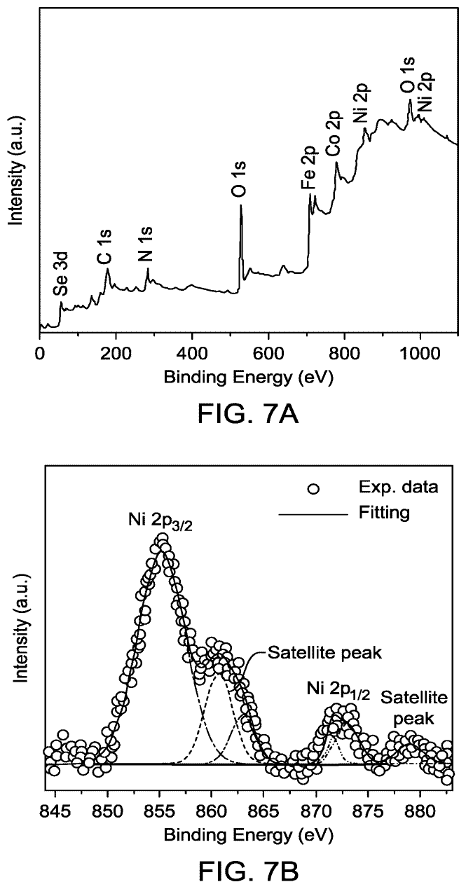

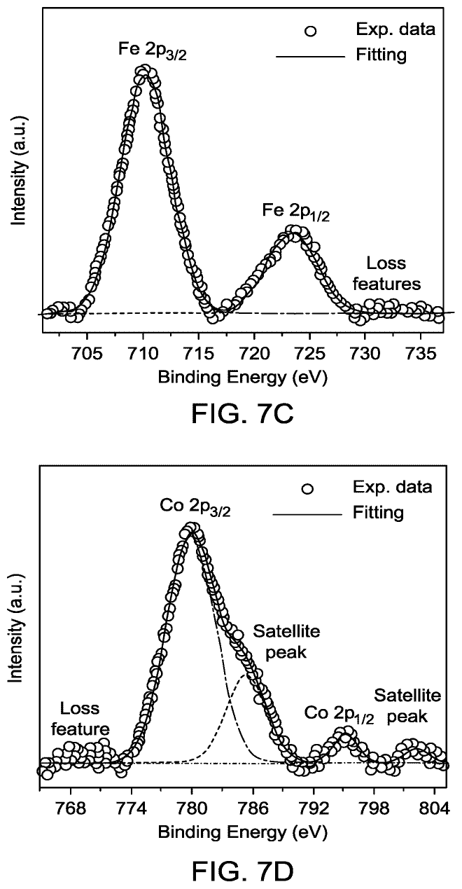

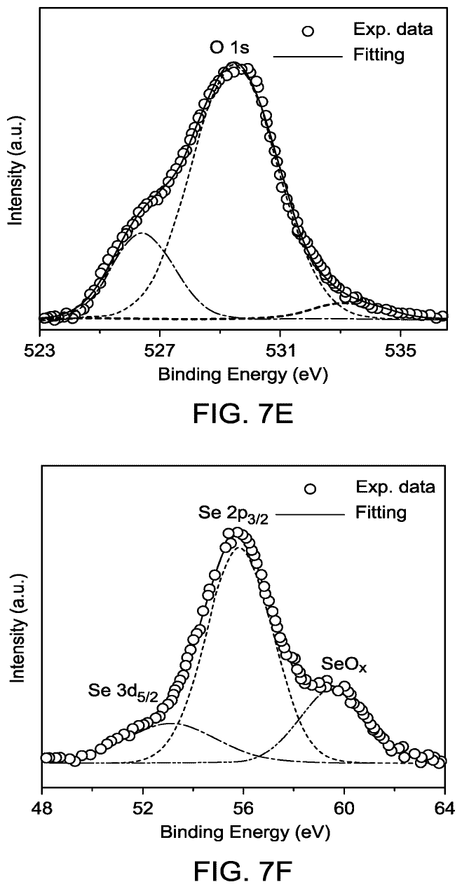

XPS study was conducted on CoNi NSFs+x % Se (x=0.00−0.20). Based on the survey scan conducted across a wide energy range, as seen in FIG. 7A, each sample element was successfully identified such as Ni 2p, Fe 2p, Co 2p, O 1s, and Se 3d. The binding energies of the representative elements were all adjusted with the reference C Is peak (284.8 eV). FIG. 7B shows the core level spectrum of Ni 2p_{3/2} at a binding energy of 855.3 eV with its overlapped satellite peak at 862.9 eV and Ni 2p_{1/2} peak at 872.9 eV with its satellite peak at 879.3 eV. The deconvoluted Ni 2p_{3/2} and Ni 2p_{1/2} spectra exhibited two characteristic peaks, revealing the presence of Ni²⁺ and Ni³⁺ states. FIG. 7C shows the core level spectra of Fe 2p_{3/2} at 710.2 eV and Fe 2p_{1/2} at 723.5 eV, with ΔE=13.3 eV proving Fe existence in the +3-oxidation state. Further, the deconvolution of Fe spectra did not introduce any peaks, indicating the presence of Fe₃+ ions only at the octahedral sites in the ferrite structure. The core spectra for Co 2p_{3/2} were detected at 780.4 eV and Co 2p_{1/2} at 795.5 eV, along with two corresponding satellite peaks at 785.6 eV and 803.1 eV, respectively, as shown in FIG. 7D. Furthermore, FIG. 7E shows the broad peak of the O 1s spectrum that was deconvoluted into three characteristic peaks at 526.8 eV, 530.4 eV, and 533.1 eV. FIG. 7F shows the Se 3d core level spectrum at 55.6 eV, deconvoluted to obtain the spin-orbit coupling between 3 d_{5/2} and 3 d_{3/2} at 53.1 eV and 55.8 eV, respectively.

### Example 10: Magnetic Property Analysis

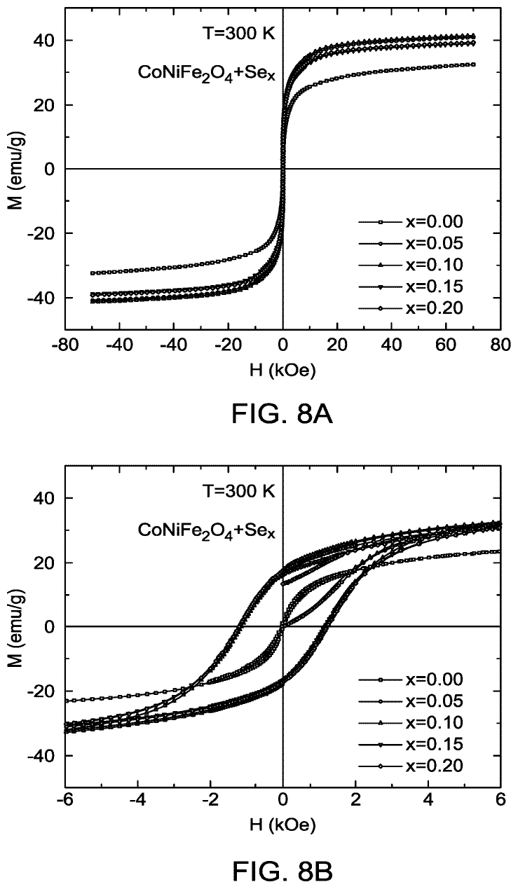

Magnetic properties of CoNi NSFs+x % Se (x=0.00-0.20) were elucidated through measurements of magnetization (M) versus an external field (H) in the range of +70 kOe. FIG. 8A illustrates the associated M(H) hysteresis loops at room temperature (RT), for which the relevant data is tabulated in Table 3. FIG. 8B shows an enlarged view of M(H) curves at RT in the range of −6 kOe≤H≤+6 kOe of CoNi NSFs+x % Se (x=0.00−0.20).

TABLE 3
Magnetic parameters of CoNi NSFs + x % Se (x = 0.00-0.20) at RT

| | Mₘₐₓ | Mₛ | Mᵣ | | | |
|---|---|---|---|---|---|---|
| x % | (emu/g) | (emu/g) | (emu/g) | SQR | H_{c}(Oe) | n_{B} (μ_{B}) |
| 0.00 | 32.50 | 33.52 | 0.78 | 0.023 | 50.0 | 1.76 |
| 0.05 | 40.88 | 41.46 | 17.59 | 0.424 | 1199.6 | 2.21 |
| 0.10 | 41.34 | 41.93 | 17.14 | 0.409 | 1149.6 | 2.26 |
| 0.15 | 38.90 | 39.47 | 16.84 | 0.427 | 1199.8 | 2.16 |
| 0.20 | 39.36 | 39.98 | 17.16 | 0.429 | 1199.7 | 2.21 |

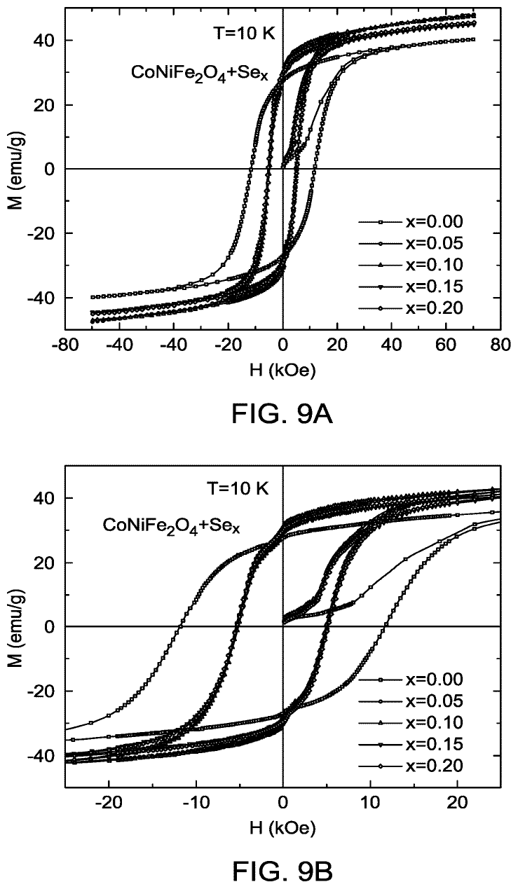

The maximum magnetization (Mₘₐₓ) values at H=70 kOe range between 32.50 emu/g and 41.34 emu/g at RT. The remanent magnetization (Mᵣ) and coercivity (H_{c}) of the host material (Co_{0.5}Ni_{0.5}Fe₂O₄) are 0.78 emu/g and 50.03 Oe, respectively. Those low values denote that the CoNi NSFs without Se indicates a superparamagnetic (SPM)-like behavior at RT. The Mᵣ values of CoNi NSFs+x % Se for x ranging from 0.05 to 0.20 are 17.59 emu/g, 17.14 emu/g, 16.84 emu/g, and 17.16 emu/g. On the other hand, while the H_{c} of CoNi NSFs+Se_{x=0.10} is 1149.6 Oe, the H_{c} value remains almost identical, around 1199 Oe for the other samples (with x=0.05, 0.15, 0.20). Except for the pristine sample, the H_{c} range indicates CoNi NSFs+x % Se (x=0.05-0.20) are magnetically hard materials at RT. Magnetic hysteresis loops and the corresponding magnetic parameters at 10 Kelvin (K) are presented in FIGS. 9A-9B and Table 4, respectively. Mₘₐₓ and Mᵣ values at 10 K are in the range of 40.17 emu/g to 47.64 emu/g and 27.55 emu/g to 30.53 emu/g, respectively, which are stronger than those at RT. While the He values of CoNi NSFs+x % Se (x=0.05−0.20) are in the interval of 5000 Oe to 5250 Oe, the CoNi NSFs without Se (x=0.00) exhibit a very high H_{c} of 11800.2 Oe as shown in FIG. 9B. In addition to temperature, particle size, shape, and magneto-crystalline anisotropy of the nanoparticles are also factors in determining the H_{c}, which governs the magnetic nature of the samples such as, soft, or hard. The XRD analysis shows that the average crystal size ranges from 13 nm to 24 nm. The crystallite size plays a role in coercivity and relevant magnetic parameters. For instance, the coercivity may get lower due to the accumulation of particles with larger sizes. As a result, the size distribution of particles is an important influence on the magnetic properties. Upon incorporation of Se, a dramatic drop in H_{c} at 10 K may be attributed to the nonuniform particle distribution. The saturation magnetization (Mₛ) at each temperature is determined through the Stoner-Wohlfarth (S-W) theory.

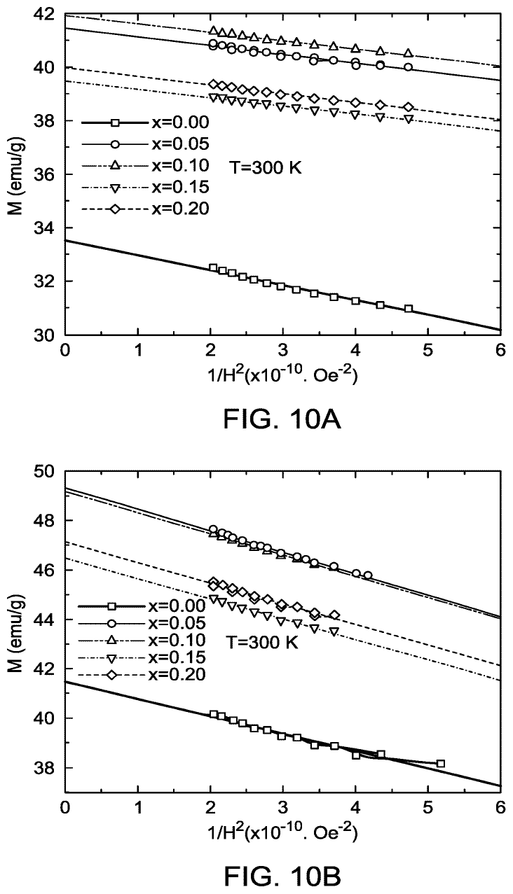

To this end, for each sample (0.00≤x≤0.20), M vs 1/H² variations were extrapolated to zero at each temperature. FIG. 10A shows M(H) vs 1/H² at RT and FIG. 10B shows M(H) vs 1/H² at 10 K for CoNi NSFs+x % Se. The Mₛ values attained at each temperature are listed in Tables 3 and 4, where Mₛ becomes the minimum for the host sample (x=0.0). Mₛ values for different nanoparticles of CoNi NSFs+x % Se (x=0.00−0.20) are in the ranges of 33.52 emu/g to 41.93 emu/g at RT and 41.48 emu/g to 49.32 emu/g at 10 K. The incorporation of Se provokes an increment in the Mₛ of CoNi NSFs+x % Se (x=0.05−0.20). The highest Mₛ is observed for CoNi NSFs+Se_{x=0.10} at RT and CoNiFe₂O₄+Se_{x=0.05} at 10 K.

TABLE 4
Magnetic parameters of CoNi NSFs + x % Se (x = 0.00-0.20) at 10 K

| | Mₘₐₓ | Mₛ | Mᵣ | | | |
|---|---|---|---|---|---|---|
| x % | (emu/g) | (emu/g) | (emu/g) | SQR | H_{c}(Oe) | n_{B} (μ_{B}) |
| 0.00 | 40.17 | 41.48 | 27.55 | 0.664 | 11800.2 | 2.18 |
| 0.05 | 47.64 | 49.32 | 30.53 | 0.619 | 5250.4 | 2.63 |
| 0.10 | 47.47 | 49.18 | 29.57 | 0.601 | 5000.2 | 2.65 |
| 0.15 | 44.85 | 46.48 | 28.92 | 0.622 | 5250.4 | 2.54 |
| 0.20 | 45.52 | 47.13 | 29.86 | 0.634 | 5250.0 | 2.61 |

In general, the size, changes in the magnetic moment, local strains, trade interactions, the number of individual sites, and the use of favorite sites all affect the variation of M and associated magnetic parameters. The characteristics of spinel ferrites are chiefly due to the metal cations in the tetrahedral (A) and octahedral (B) sites interacting with each other. These exchange interactions are more important than those between A-A and B-B. In this context, the dependence of M on H for CoNi NSFs+x % Se (x=0.00−0.20) is primarily driven by those agents influencing the strength of the A-B interactions. The enhancement of Mₘₐₓ, Mₛ, and Mᵣ with Se compared to those without Se (x=0.00) are attributed to reducing the distance separating the magnetic ions, enhancing A-B superexchange interactions. Moreover, a prominent increment in both Mᵣ and H_{c} with reducing temperature (from RT to 10 K) reflects the reduced thermal fluctuations of magnetic moments.

The magnetic moment (n_{B}) induced may be calculated through the Mₛ,

$${n}_{B} = {M}_{A} \times {M}_{s} / 5585$$

where M_{A} stands for molecular weight. The ng values of CoNi NSFs+x % Se (x=0.00-0.20) are found to be in the interval of 1.76 μ_{B}≤n_{B}≤2.26 up and 2.18 μ_{B}≤n_{B}≤2.65 up at RT and 10 K, respectively, as may be seen from Table 3 and Table 4. The np increases with decreasing temperature for each sample. Further, the ng of Se-doped CoNi NSFs is higher than that of undoped CoNi NSFs at each temperature. The enhancement of magnetization with Se (at both RT and 10 K) is due to factors, such as spin pinning at the interface of nanoparticles. Upon the incorporation of Se, there is an increase in the strength of the spin interaction owing to the alteration of bond lengths connecting cations and anions and the augmentation of spin imbalance due to dissimilar ionic radii of Se and host atoms. Table 1, listing the Rietveld refined structure parameters, demonstrates that the unit cell is getting larger and that the volume enlarges with Se dopant concentration (584.10 Å³ to 590.87 Å³). The accompanying lattice distortion tunes the magnetic characteristics. The magnetic parameters listed in Table 3 and Table 4, for CoNi NSF+x % Se (x=0.00−0.20) barely fluctuate, mainly due to morphological changes. Se can bring stable electronic states at the surface and contribute to magnetism. The results indicate that Se is harnessed to tune the magnetic properties of Co_{0.5}Ni_{0.5}Fe₂O₄ nanostructures.

The squareness ratio (a way to measure the “squareness” of the hysteresis loop) defined by SQR=Mᵣ/Mₛ, is another parameter in the magnetic properties. The SQR values of both host and Se-doped samples at RT and 10 K are listed in Table 3 and Table 4, respectively. They are in the range of 0.0230.429 (SQR<0.5) at RT and 0.601-0.664 (SQR>0.5) at 10 K. The pristine sample (x=0.00) displays a very small SQR value less than 0.1 at is attributed to the very small crystallites/particle size that is comparable (or lesser) to the critical superparamagnetic domain size. Indeed, it is reported that CoFe₂O₄ nanoparticles display a critical superparamagnetic domain size of about 10 nm.

The XRD results revealed that the pristine sample has a DXRD value of about 13 nm that is comparable to the mentioned critical superparamagnetic domain size, confirming the observed superparamagnetic behavior in the pristine sample at RT. The remaining samples showed SQR values around 0.40-0.42 at RT, implying the formation of a single domain structure with uniaxial symmetry. An SQR value less than 0.5 may be ascribed to the influence of a surface spin disorder. An SQR higher than 0.5 designates the creation of multi-magnetic domains and reflects one of the major characteristics of hard nanocomposite magnets. In respect to the present disclosure, SQR>0.5 is observed for all samples at 10 K. The present findings are consistent with the results observed for Se-doped Bi ferrite nanosheets.

### Example 11: Evaluation of HER Activity

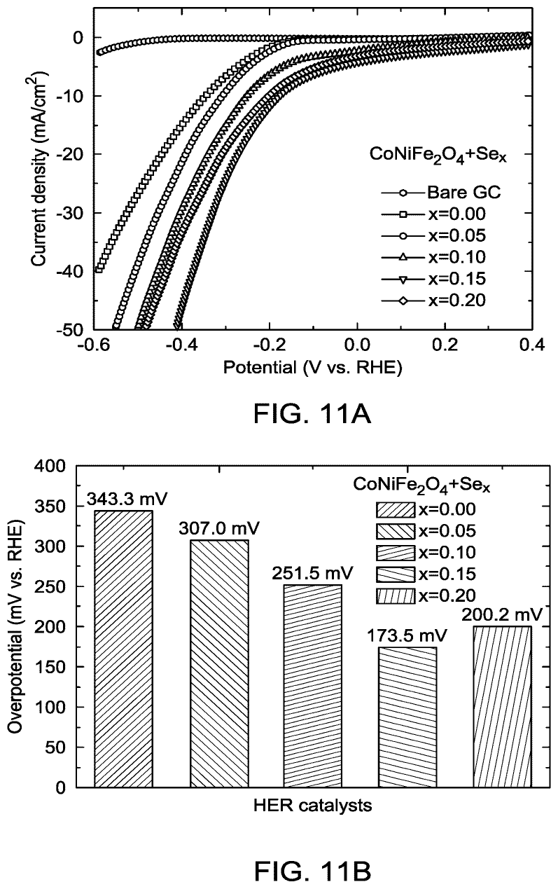

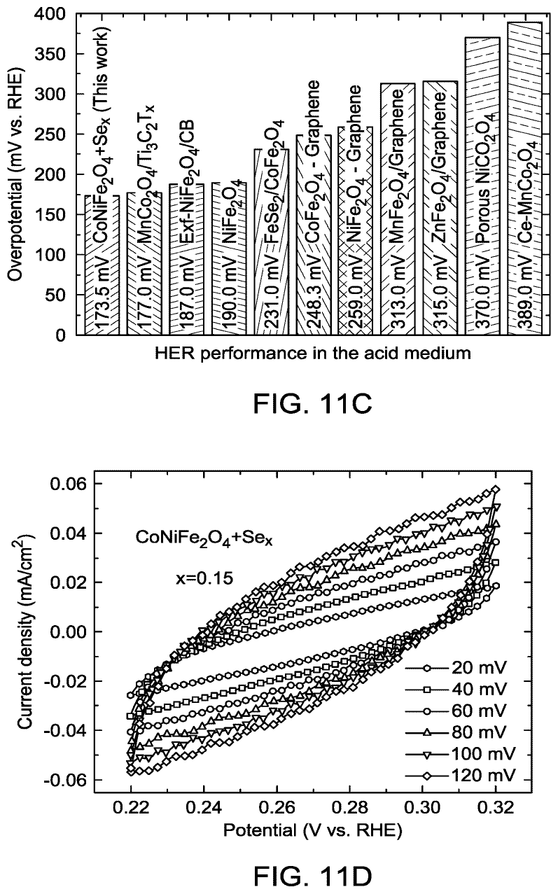

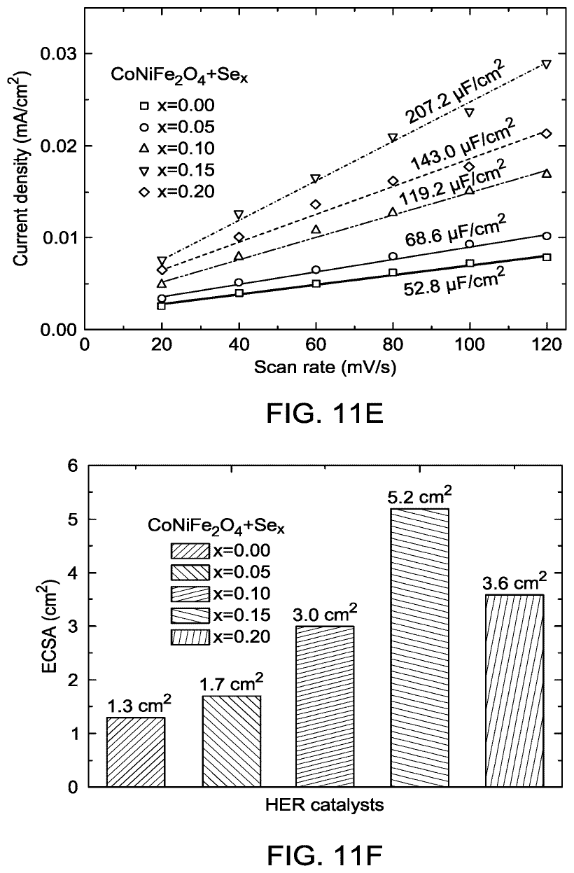

The electrocatalytic HER measurements were conducted in 0.5 M H₂SO₄ solution with pH=0.3 using CoNi NSFs+x % Se (x=0.00−0.20) as a cathode. Linear sweep voltammetry (LSV) was applied to study how the current was varied across a certain range of potentials for HER during reduction CoNi NSFs+x % Se (x=0.00−0.20) at the GC electrode. The LSV curves for all catalysts taken at the same scan rate of 10 mV/s are depicted in FIG. 11A. Compared to Se-doped CoNi electrodes, the undoped CoNi demonstrated poor HER performance with large overpotential such as, 343.5 mV at a 10 mA/cm² current density. The catalytic activity for HER was enhanced in the case of % Se (x=0.15) doped into the CoNi matrix and reached 173.5 mV with a 170 mV anodic shift from the bare CoNi electrode at a 10 mA/cm² overpotential as depicted in FIG. 11A. The higher ratio of % Se (x=0.20) in the CoNi matrix suppresses the catalytic HER activity, which is related to the aggregation generated by the greater concentration of Se, which tends to decrease the HER performance. For a better understanding, the overpotential histogram of different electrodes at −10 mA/cm² is shown in FIG. 11B. The performance of CoNi NSFs+x % Se (x=0.15) as an electrocatalyst for HER was compared to that of other HER catalysts reported in the literature [See: Kananke-Gamage, C. C. W.; Ramezanipour, F. Variation of the Electrocatalytic Activity of Isostructural Oxides Sr2LaFeMnO7 and Sr2LaCoMnO7 for Hydrogen and Oxygen-Evolution Reactions, Dalton Trans., 2021, 50, 14196-14206, incorporated herein by reference in its entirety] as shown in FIG. 11C.

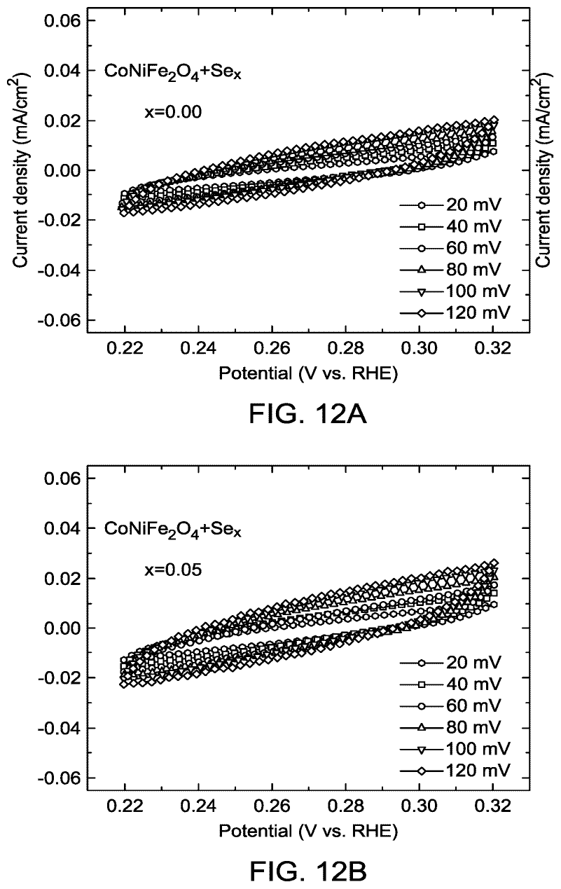

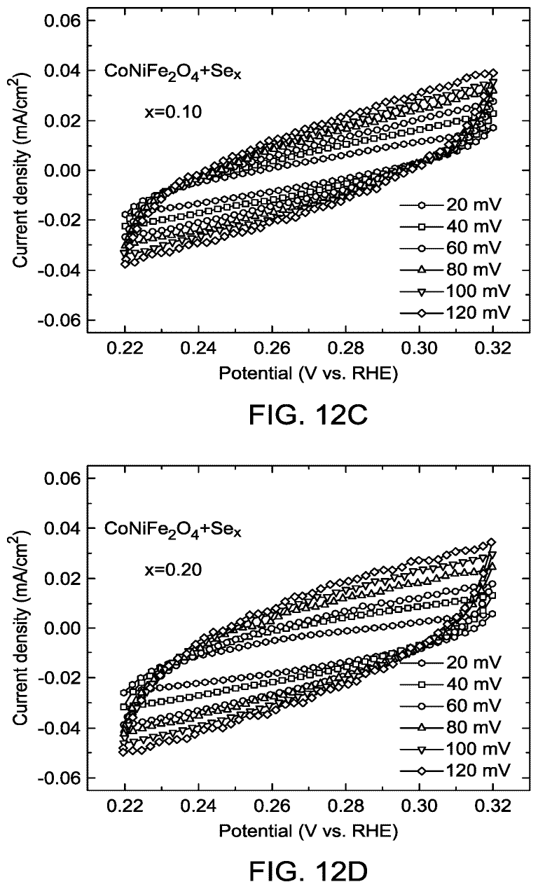

The electrochemically active surface area (ECSA) was assessed to confirm the assumption that CoNi NSFs+x % Se (x=0.15) have an impact on the improved performance of HER. The ECSA is extracted from double-layer capacitance (C_{dl}) by measuring the CVs from 20 mV/s to 120 mV/s scan rates as depicted in FIG. 11D and Table 1. Further, the calculation of the C_{dl} value is shown in FIG. 11E. The ECSA plots for all catalysts are depicted in FIG. 11F. For instance, an ESCA of 1.3 cm², 1.7 cm², 3.0 cm², 5.2 cm², and 3.6 cm² is required for CoNi NSFs+x % Se (x=0.00-0.20) electrodes. Compared to Se-doped CoNi electrodes, the undoped CoNi demonstrated poor HER performance due to the low ECSA of 1.3 cm². Increasing the Se-doped concentration on the CoNi matrix enhances the ECSA and reaches 5.2 cm² in the case of % Se (x=0.15) doped into the CoNi matrix. After that, the ECSA is unexpectedly reduced as the concentration of Se doped into the CoNi matrix increases. It may be because the Se is covering up the active sites of the CoNi matrix and making more recombination centers instead of making more active sites. This indicates that CoNi NSFs+x % Se (x=0.15) electrode has a high ECSA, which is responsible for higher electrode activity for HER. Table 5 shows the calculated typical HER parameters (overpotential, Tafel slope, ECSA) of the CoNi NSFs+x % Se (x=0.00−0.20) for more clarity under comparable circumstances. FIGS. 12A-12D shows CV polarization curves of various samples of CoNi NSFs+x % Se (x=0.00-0.20).

TABLE 5
HER parameters of CoNi NSFs + x % Se (x = 0.00-0.20).

| x % | η₁₀ (mV) | b (mV/dec) | C_{dl} (μF/c²) | ECSA (cm²) |
|---|---|---|---|---|
| 0.00 | 343.3 | 162 | 52.8 | 1.3 |
| 0.05 | 307.0 | 120 | 68.6 | 1.7 |
| 0.10 | 251.5 | 108 | 119.2 | 3.0 |
| 0.15 | 173.5 | 91 | 207.2 | 5.2 |
| 0.20 | 200.2 | 102 | 143.0 | 3.6 |

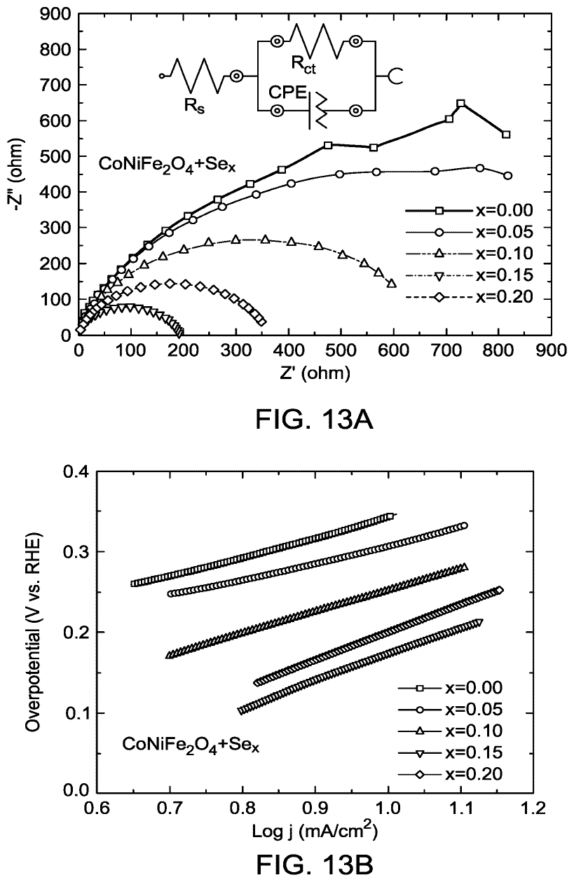

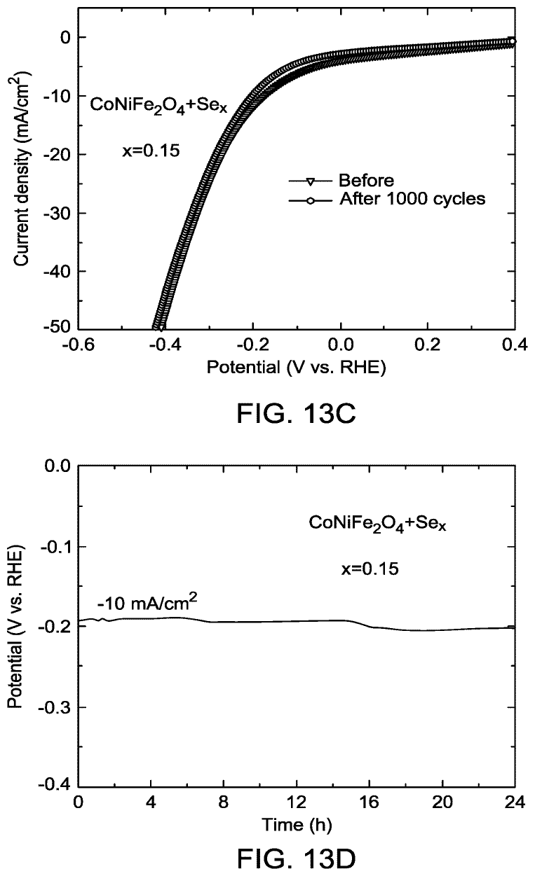

As shown in FIG. 13A, the EIS analysis was performed to understand the efficacy of the catalyst in the charge transporting at the semiconductor electrolyte interface (SEI) in a 0.5 M H₂SO₄ electrolyte solution. The electron transfer at SEI occurs quickly and strongly in the tiny semicircle, indicating significant electrocatalytic activity. The Nyquist plot of CoNi NSFs+x % Se (x=0.00-0.20) was measured at an overpotential of 173.5 mV, and frequencies range from 0.1 Hz to 105 Hz, as depicted in FIG. 13A. The inset of FIG. 13A shows a simulation of the equivalent circuit, where R_{S} and R_{ct} are the resistance of the electrolyte solution and the resistance of the charge-transfer electrolyte interface, respectively. Also, the CoNi NSFs+x % Se (x=0.15) electrocatalyst with the smallest arc radius had a lower charge-transfer resistance than other catalysts. This showed that it improved the performance of the HER and was consistent with the results observed in FIG. 11A.

Moreover, the Tafel plot was measured to get more insight into the electrocatalytic kinetics for HER by x % Se doping (x=0.00−0.20) into the CoNi matrix, as shown in FIG. 13B. The slope of catalysts was determined using the Tafel relation n=b log (j)+a, where ‘η’, ‘j’, ‘b’, and ‘a’ denote overpotential, current density, slope, and constant, respectively. The calculated Tafel slope of CoNi NSFs+x % Se (x=0.00−0.20) catalysts exhibits slopes ranging from 91 mV/dec to 162 mV/dec. The Tafel slope values of the CoNi NSFs+x % Se (x=0.15) Heyrovsky process 40 mV/dec, and the Volmer process 120 mV/dec, respectively. In the first electrocatalyst were as low as 91 mV/dec, which supports that this material follows the Volmer-Heyrovsky rate-determining step in HER.

In general, when an acidic medium performs HER, three primary processes are at work, the Tafel process 30 mV/dec, the stage, which is called the Volmer reaction, the hydrogen atom absorbs a proton that has been released from the electrode surface. In the Heyrovsky process, H_{ads} may merge with a proton and an electron to create hydrogen molecules. The Tafel process suggests recombining two H_{ads} species to create molecules of hydrogen. The Volmer-Heyrovsky route involves the Volmer and Heyrovsky processes and is the most common way for the HER mechanism to proceed. The estimated Tafel slope of 91 mV/dec for the most effective electrocatalyst CoNi NSFs+x % Se (x=0.00−0.20) shows that the reaction goes through the rate-determining Volmer-Heyrovsky step.

In addition to HER activity, electrocatalyst stability was assessed. According to the results above, a CoNi NSFs+x % Se (x=0.15) electrode may be employed realistically for electrocatalytic hydrogen evolution applications. The findings of employing the chronopotentiometry (CP) method to access the stability of the CoNi NSFs+x % Se (x=0.15) in a 0.5 M H₂SO₄ solution at 10 mA/cm² are shown in FIG. 13D. The horizontal line in the graph depicts the stability of the Se-doped CoNi NSF catalyst over a 24 h period. Further, as illustrated in FIG. 13C, the LSV stability studies were performed after 1000 cycles. The LSV of the CoNi NSFs+x % Se (x=0.15) catalyst shifted around 5 mV, due to the diminishing of the electrochemically active surface area affected by the accumulation of ions in the pores of the catalyst.

Numerous modifications and variations of the present disclosure are possible in light of the above teachings. It is therefore to be understood that within the scope of the appended claims, the invention may be practiced otherwise than as specifically described herein.

1. An electrocatalyst, comprising:
a substrate; and
CoₓNi_{y}Fe₂O₄ nanoparticles,
wherein x+y=1,
wherein the CoₓNi_{y}Fe₂O₄ nanoparticles are doped with 0.01 weight percentage (wt. %) to 1.0 wt. % selenium (Se), based on a total weight of the CoₓNi_{y}Fe₂O₄ nanoparticles,
wherein the CoₓNi_{y}Fe₂O₄ nanoparticles have a polygonal shape, and
wherein the CoₓNi_{y}Fe₂O₄ nanoparticles are dispersed on the substrate to form the electrocatalyst.

2. The electrocatalyst of claim 1, wherein the CoₓNi_{y}Fe₂O₄ nanoparticles have an average size of 5 nanometers (nm) to 20 nm.

3. The electrocatalyst of claim 1, wherein the CoₓNi_{y}Fe₂O₄ nanoparticles have a polygonal shape with 4 to 6 sides.

4. The electrocatalyst of claim 1, wherein the CoₓNi_{y}Fe₂O₄ nanoparticles are aggregated forming a porous structure.

5. The electrocatalyst of claim 4, wherein the porous structure has an average pore size of 15 nm to 26 nm.

6. The electrocatalyst of claim 4, wherein the porous structure has a BET surface area of 50 m²/g to 100 m²/g.

7. The electrocatalyst of claim 4, wherein the porous structure has a pore volume of 0.3 cm³/g to 0.6 cm³/g.

8. The electrocatalyst of claim 1, wherein the CoₓNi_{y}Fe₂O₄ nanoparticles comprise 25 wt. % to 35 wt. % O, 30 wt. % to 40 wt. % Fe, 10 wt. % to 20 wt. % Co, 10 wt. % to 20 wt. % Ni, and 0.01 wt. % to 1.0 wt. % Se, based on a total weight of the CoₓNi_{y}Fe₂O₄ nanoparticles.

9. The electrocatalyst of claim 1, wherein the CoₓNi_{y}Fe₂O₄ nanoparticles have an average crystal size of 14 nm to 25 nm.

10. The electrocatalyst of claim 1, wherein the CoₓNi_{y}Fe₂O₄ nanoparticles have a maximum magnetization of 44 electromagnetic unit per gram (emu/g) to 48 emu/g at 10 Kelvin (K).

11. The electrocatalyst of claim 1, wherein the CoₓNi_{y}Fe₂O₄ nanoparticles have a maximum magnetization of 35 emu/g to 45 emu/g at room temperature.

12. The electrocatalyst of claim 1, wherein the substrate is glassy carbon.

13. The electrocatalyst of claim 1, wherein the electrocatalyst is made by a method, comprising:
mixing an iron salt, a nickel salt, and a cobalt salt in citric acid to form a mixture;
adding a base to the mixture to adjust a pH to 6-8 and heating to a temperature of 350-450° C. to form nanoparticles;
mixing the nanoparticles with selenium and sonicating for at least 30 minutes to form a suspension;
irradiating the suspension with a pulsed laser to form the CoₓNi_{y}Fe₂O₄ nanoparticles; and
coating the CoₓNi_{y}Fe₂O₄ nanoparticles on the substrate.

14. The electrocatalyst of claim 13, wherein the pulsed laser has a wavelength of 500 nm to 600 nm and a pulse duration of 5 nanoseconds (ns) to 15 ns.

15. The electrocatalyst of claim 13, wherein the mixture comprises a molar ratio of the iron salt to nickel salt to cobalt salt of 1-10 to 1-10 to 1-10.

16. A method of generating hydrogen, comprising:
applying a potential of 0.1 to 1.0 V to an electrochemical cell,
wherein the electrochemical cell is at least partially submerged in an aqueous solution,
wherein on applying the potential the aqueous solution is reduced thereby forming hydrogen,
wherein the electrochemical cell comprises:
the electrocatalyst of claim 1; and
a counter electrode.

17. The method of claim 16, wherein the aqueous solution further comprises an acid.

18. The method of claim 16, wherein the electrocatalyst has an overpotential of 170 millivolts (mV) to 310 mV at a current density of 10 milliampere per square centimeter (mA/cm²).

19. The method of claim 16, wherein the electrocatalyst has a Tafel slope of 90 mV/decade to 120 mV/decade.

20. The method of claim 16, wherein the electrocatalyst has an electrochemical active surface area of 3-6 cm².
